(19) United States
(12) Patent Application Publication
(10) Pub. No.: US 2011/0268185 A1
(43) Pub. Date: Nov. 3, 2011

(54) DELIVERY SYSTEM AND METHOD AND CONVERSION DEVICE

(76) Inventors: Kazuteru Watanabe, Tokyo (JP); Kazunori Ozawa, Tokyo (JP)

(21) Appl. No.: 13/143,137

(22) PCT Filed: Jan. 6, 2010
(86) PCT No.: PCT/JP2010/050056

§ 371 Date: Jul. 1, 2011

(30) Foreign Application Priority Data
Jan. 8, 2009 (JP) 2009-002990

(51) Int. Cl. H04N 7/26

(52) U.S. Cl. 375/240.03; 375/240.02; 375/E07.126

(57) ABSTRACT

A delivery system, which distributes at least one stream to a terminal over a network, includes a conversion apparatus that in distributing encoded data of a moving image specified by a terminal, re-uses information of the encoded data to convert the encoded data so that the encoded data converted fits in with at least one of capability information and status of a network notified from the terminal and transmits the encoded data converted to the terminal.

### RELATED APPLICATION

The present application is the National Phase of PCT/JP2010/050056, filed Jan. 6, 2010, which claims priority rights based upon JP Patent Application JP-2009-002990 filed in Japan on Jan. 8, 2009. The total contents of the JP Patent Application of the senior filing data are to be incorporated and disclosed by reference in the present specification.

### TECHNICAL FIELD

This invention relates to an image conversion technique and, more particularly, to a delivery method and a delivery system including a conversion apparatus that re-encodes an encoded bit stream of a moving picture in keeping with the network or a terminal, and to the conversion apparatus.

### BACKGROUND

In these days, H.262 and H.263, recommended by ITU-T (International Telecommunication Union Telecommunication Standardization Sector), and MPEG-4 (Moving Picture Expert Group Phase 4), internationally standardized by ISO/IEC (International Organization for Standardization/International Electrotechnical Commission), have been known as moving picture compression encoding systems for efficiently transmitting a moving image signal at a low bit rate. Also, 1-1.264/MPEG-4 AVC (Advanced Video Coding), internationally standardized by the ITU-T and ISO/IEC, is attracting notice as being a system capable of transmitting a moving image signal more efficiently than the above mentioned moving picture compression encoding schemes.

The moving picture compression encoding scheme uses intra-prediction that effects encoding using only picture data of the current frame and inter-prediction that effects encoding using an image of a past frame and/or an image of a future frame as a reference.

In the intra-prediction, when encoding an input image frame, DCT (Discrete Cosine Transform) is applied on a per unit basis called a macro-block to produce DCT coefficients which are then subjected to variable length encoding. Or, prediction is performed on a per macro block basis obtained on further sub-dividing the macro-block, using pixels of near-by blocks, such as left or upper blocks. Then, DCT or DIT (Discrete Integer Transform) is applied to a residual between the input image signal and a prediction signal to generate DCT or DIT coefficients, which are then encoded using the variable length encoding technique.

With the inter-prediction, in encoding an input image frame, motion compensation prediction is carried out with decoded pixels of past and/or future frames to find a prediction residual signal. DCT or DIT is then applied to the residual, and then a motion vector as well as DCT coefficients are encoded using the variable length encoding technique.

In these days, such a system which makes terminals of different sorts, such as mobile phones or PCs, and terminals which are of the same sort and differing in functions, coexist in the same network is also attracting notice.

In distributing moving picture data to a terminal on a network, attention should be directed to a fact that there is a difference in the capabilities of terminals, depending upon the sorts of the terminals, such as mobile phones or PCs, or upon the functions of the terminals. It is thus necessary to convert a moving picture stream into one matched to the different terminals.

In data communication for moving pictures, limitations imposed on image size that may be displayed, bit rate or frame rate may differ from one terminal to another. It is thus necessary to provide a conversion apparatus that is matched in each terminal of interest.

Also, the frequency band allocated to each terminal may become broader or narrower depending upon the degree of congestion of networks. It is thus necessary to change the image size, bit rate or the frame rate depending upon network status.

However, to convert the image size, bit rate or the frame rate of a compression encoded bit stream (encoded data) of a moving picture received, it is necessary to decode the encoded data, convert the image size, bit rate and the frame rate and to finally re-encode the moving image signal.

As a related technique to convert a moving image, Patent Document 1 shows an image delivery system designed for distributing to each user a moving image compressed to a variable image size and image quality in accordance with variable image compression formats. With the image delivery system, it is possible for a user terminal to specify to the image delivery system the format of compression as well as the size and the quality of images distributed. The image delivery system includes a means for determining image compression format and image parameters including image size as well as image quality under instructions from the user terminal, a means for generating a bit stream (compressed image data) in accordance with the determined image compression format, image size and image quality, a means for distributing the so generated bit stream to the user terminal, and a means for billing the user in accordance with the so determined image compression format, image size and the image quality.

In Patent Document 2, there is disclosed an encoded data image size conversion apparatus whereby image size of data encoded with the use of motion-compensated prediction and orthogonal transform may be converted to an optimum image quality with ease. In the encoded data image size conversion apparatus, macro-block image data, converted from input encoded image data to a preset image size, is obtained by an image data conversion unit. The motion vector of the encoded image data supplied is multiplied in a motion vector conversion unit by a preset conversion ratio to yield a converted motion vector for the macro-block image data. In case the change ratio is less than unity, an integrated motion vector is found depending upon the variance of a plurality of converted motion vectors necessary for conversion of the image data. Image encoded data having a size changed image is obtained using the integrated motion vector and the macro-block image data as found.

In Patent Document 3, there is disclosed a moving image delivery apparatus in which a series of images displayed in a frame-by-frame playback, such as images with a reduced number of colors, may be displayed with high quality on a display of a mobile phone having a high-definition display screen. A request reception unit accepts a transmission request for a moving image from the mobile phone terminal. An apparatus type determining unit determines a type of the mobile terminal apparatus, and a moving image format conversion unit converts moving image data so that the format will fit in with the image display size of the mobile phone terminal by way of performing image size conversion. In case the mobile phone terminal apparatus is unable to display moving image data but is able to display multi-media images composed of a plurality of frames with high image quality in a frame-by-frame playback a moving image conversion unit converts the moving image data into multi-median image data. A image output unit takes the data capacity of the mobile terminal apparatus into account in transmitting the multi-median image data to the mobile phone terminal that made the request for the multi-median image. As will become apparent from the description to follow, the inventions disclosed in the Patent Documents 1 to 3 are totally different from the present invention.

### Patent Document 1:

JP Patent Kokai Publication No. JP2002-82861A

### Patent Document 2:

JP Patent Kokai Publication No. JP2002-344973A

### Patent Document 3:

JP Patent Kokai Publication No. JP2004-356998A

### SUMMARY

The following is an analysis made by the present invention.

It is a calculation amount necessary for re-encoding that is of utmost concern in the conversion of image size, bit rate, or frame rate. The reason is that calculations for re-prediction become necessary, if in distributing a stream to terminals of various capabilities, it is necessary to convert the stream.

Moreover, if, in distributing a stream to terminals of various capabilities; a stream needs to be converted and information of the stream received is used unchanged, the image quality is deteriorated.

Moreover, if, in distributing a stream in an environment with variable network statuses, it should become necessary to convert the stream, it becomes necessary to perform calculations for re-prediction. If, in distributing the stream in an environment with variable network statuses, the stream needs to be converted, and the information of the stream received is used unchanged, the image quality is deteriorated.

It is an object of the present invention to provide a system and a method for delivery, and a conversion apparatus, in which, when it is necessary to convert a stream in distributing a stream, the conversion may be speeded up.

It is another object of the present invention to provide a system and a method for delivery, and a conversion apparatus, in which, if, in distributing a stream, such stream needs to be converted, the information of the stream received is used to execute the conversion such as to suppress deterioration of the image quality.

To accomplish at least one of the above objects, the present invention has substantially the following configuration, though not limited thereto:

According to the present invention, there is provided a delivery system that distributes at least one stream to a terminal over a network, and that comprises a conversion apparatus which receives encoded data of moving image which is an object for delivery specified by the terminal, from the delivery server, converts the encoded data based upon at least one of capability information of the terminal, function information of the terminal and a status of the network, notified from the terminal, and transmits the converted encoded data to the terminal.

According to the present invention, there is provided a delivery system that distributes at least one stream to a terminal over a network, and that comprises a conversion apparatus which, in distributing the encoded data of a moving image specified by the terminal, determines, based upon the function information of the terminal notified from the terminal, whether or not to convert the encoded data, converts the encoded data determined to be converted and transmits the converted encoded data to the terminal.

According to the present invention, there is provided a delivery method that distributes at least one stream to a terminal over a network, in which, in distributing encoded data of a moving image specified by the terminal, a conversion apparatus re-uses the information of the encoded data to convert the encoded data so that the encoded data converted fits in with at least one of the capability information of the terminal and the status of the network notified from the terminal and transmits the encoded data converted to the terminal.

According to the present invention, there is provided a delivery method that distributes a stream to a terminal, in which, in distributing the encoded data of the moving image specified by the terminal, a conversion apparatus determines, based upon the function information of the terminal from the terminal, whether or not to convert the encoded data, converts the encoded data determined to be converted and transmits the converted encoded data to the terminal.

According to the present invention, there is provided a program causing a computer of a conversion apparatus to execute the processing of:

in distributing encoded data of a moving image specified by the terminal,

re-using the information of the encoded data to convert the encoded data so that the encoded data converted fits in with capability information or function information of the terminal and a status of the network notified from the terminal; and

transmitting the encoded data converted to the terminal.

According to the present invention, there is provided a program causing a computer of a conversion apparatus to execute the processing of:

in distributing encoded data of a moving image specified by a terminal over a network,

determining, based upon the function information of the terminal from the terminal, whether or not to convert the encoded data;

converting the encoded data determined to be converted; and

transmitting the converted encoded data to the terminal.

According to the present invention, there is provided a conversion apparatus that includes

a reception unit that receives encoded data from a delivery server, the delivery server transmitting encoded data specified by a terminal to the conversion apparatus;

an information exchange unit that exchanges, with the terminal, capability information or function information of the terminal, and information on a status of the network;

a transcoder that decodes encoded data received from the delivery server into image data, the transcoder converting decoded image data so that the decoded image data converted fits in with at least one of capability information and status of a network, notified by the terminal, the transcoder encoding the decoded image data converted, the transcoder exploiting encoding information of the encoded data received to encode the decoded image data; and

a transmission unit that transmits encoded data output from the transcoder over the network to the terminal.

According to the present invention, in case, in distributing a stream, it should become necessary to convert the stream, such conversion may be speeded up. Moreover, according to the present invention, if, in distributing a stream, the stream needs to be converted, the stream may be converted without deterioration of image quality by using the information of the stream received.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing a configuration of a moving image delivery system according to Exemplary Embodiments 1 and 4 to 13 of the present invention.

FIG. 2 is a diagram showing a configuration of a moving image transcoder of Exemplary Embodiment 1 of the present invention.

FIG. 3 is a diagram showing a configuration of an encoding unit of Exemplary Embodiments 1 to 6 of the present invention.

FIG. 4 is a diagram showing a configuration of a moving image delivery system of Exemplary Embodiments 2 and 4 to 13 of the present invention.

FIG. 5 is a diagram showing a configuration of a moving image delivery system of Exemplary Embodiments 3 and 4 to 13 of the present invention.

FIG. 6 is a diagram showing a configuration of a moving image transcoder of Exemplary Embodiment 4 of the present invention.

FIG. 7 is a diagram showing a configuration of a moving image transcoder of Exemplary Embodiment 5 of the present invention.

FIG. 8 is a diagram showing a configuration of a moving image transcoder of Exemplary Embodiment 6 of the present invention.

FIG. 9 is a diagram showing a configuration of an encoding unit of Exemplary Embodiment 6 of the present invention.

FIG. 10 is a diagram showing a configuration of a moving image transcoder of Exemplary Embodiment 7 of the present invention.

FIG. 11 is a diagram showing a configuration of an encoding unit of Exemplary Embodiment 7 of the present invention.

FIG. 12 is a diagram showing a configuration of a moving image transcoder of Exemplary Embodiment 8 of the present invention.

FIG. 13 is a diagram showing a configuration of an encoding unit of Exemplary Embodiment 8 of the present invention.

FIG. 14 is a diagram showing a configuration of a moving image transcoder of Exemplary Embodiment 9 of the present invention.

FIG. 15 is a diagram showing a configuration of an encoding unit of Exemplary Embodiment 9 of the present invention.

FIG. 16 is a diagram showing a configuration of a moving image transcoder of Exemplary Embodiment 10 of the present invention.

FIG. 17 is a diagram showing a configuration of an encoding unit of Exemplary Embodiment 10 of the present invention.

FIG. 18 is a diagram showing a configuration of a moving image transcoder of Exemplary Embodiment 11 of the present invention.

FIG. 19 is a diagram showing a configuration of an encoding unit of Exemplary Embodiment 11 of the present invention.

FIG. 20 is a diagram showing a configuration of a moving image transcoder of Exemplary Embodiment 12 of the present invention.

FIG. 21 is a diagram showing a configuration of a moving image delivery system of Exemplary Embodiment 13 of the present invention.

FIG. 22 is a diagram showing a configuration of a moving image transcoder of Exemplary Embodiments 13 to 15 of the present invention.

FIG. 23 is a diagram showing a configuration of an encoding unit according to Exemplary Embodiments 13 to 15 of the present invention.

FIG. 24 is a diagram showing a configuration of a moving image delivery system of Exemplary Embodiment 14 of the present invention.

FIG. 25 is a diagram showing a configuration of a moving image delivery system of Exemplary Embodiment 15 of the present invention.

### PREFERRED MODES

Preferred modes for carrying out the present invention will now be described. The delivery system according to preferred modes distributes one or more streams to a terminal over a network. In distributing encoded data of a moving image stream (moving image encoded data), specified from the terminal, the delivery system re-encodes the encoded data, received from the delivery server, as the delivery system re-uses the information of the encoded data received, so that the resulting re-encoded data will fit in with the capability information notified from the terminal. The re-encoded data are distributed to the terminal.

When transmitting encoded data to a terminal, the delivery system according to the present invention re-uses the information of the encoded data to re-encode the data so that the resulting re-encoded data will fit in with the network status notified from the terminal. The so re-encoded data are distributed to the terminal.

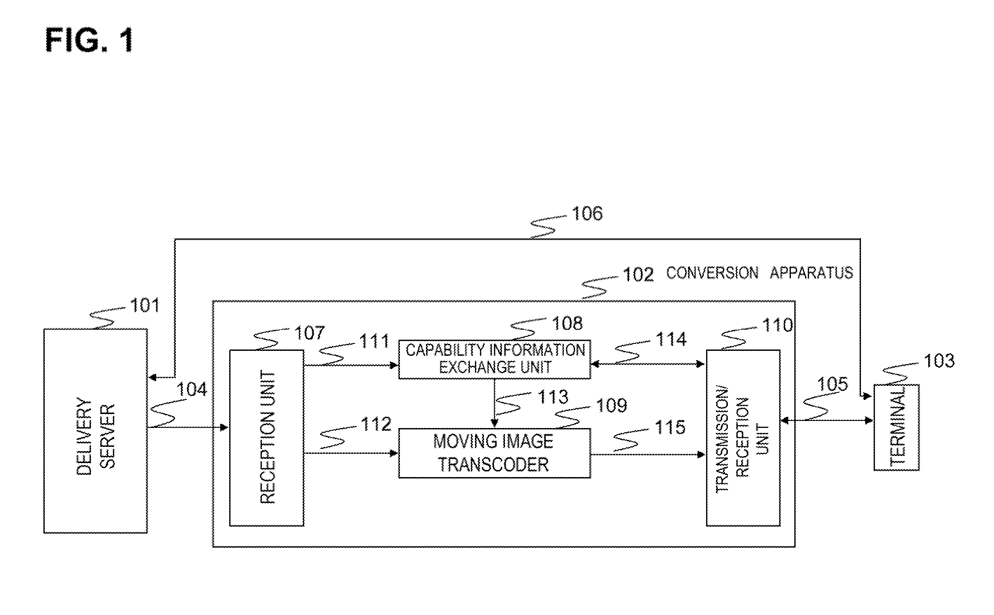

More specifically, in preferred modes, a moving image delivery system according to an aspect of the present invention, includes a delivery server (101 of FIG. 1) that transmits encoded data specified by a terminal (103 of FIG. 1) to a conversion apparatus (102 of FIG. 1). The moving image delivery system also includes the conversion apparatus (102 of FIG. 1) in turn including a capability information exchange unit (108 of FIG. 1) that exchanges the capability information between it and the terminal (103), and a moving image transcoder (109 of FIG. 1). The moving image transcoder re-encodes the above mentioned encoded data received from the delivery server (101). At this time, the moving image transcoder re-uses the information of the encoded data, so that the resulting re-encoded data will fit in with the capability information or the network status received from the terminal (103). The conversion apparatus transmits the encoded data to the terminal (103). The terminal (103) exchanges the capability information between it and the conversion apparatus (102) and receives the moving image data specified.

The delivery server (101) transmits encoded data, specified by the terminal (103), to the conversion apparatus (102).

The conversion apparatus (102) exchanges the capability information between it and the terminal (103), while re-encoding the encoded data, received from the delivery server (101), as it re-uses the information of the encoded data, so that the resulting re-encoded data will fit in with the capability information that has been notified from the terminal (103). The resulting re-encoded data are transmitted to the terminal (103).

When notified of the network status from the terminal (103), the conversion apparatus (102) re-encodes the encoded data, received from the delivery server (101), as the conversion apparatus re-exploits the information of the encoded data, so that the resulting re-encoded data will fit in with the network status. The resulting re-encoded data are then transmitted to the terminal (103).

The conversion apparatus (102) may determine whether or not to convert the encoded data, based upon the terminal's function information notified from the terminal (103). The conversion apparatus may then transmit the stream to the terminal. According to the present invention, if, in distributing a stream to a terminal having a variable capability, it is necessary to convert the stream, it can be converted expeditiously.

According to preferred modes, if, in distributing a stream to a terminal having a variable capability, it is necessary to convert the stream, such conversion may be made, using the information of the stream received, such as to suppress image quality deterioration.

According to preferred modes, if, in distributing a stream in an environment with variable network statuses, it is necessary to convert the stream, the conversion can be carried speedily.

According to preferred modes, if, in distributing a stream in an environment wherein a network status changes, it is necessary to convert the stream, such conversion may be made, using the information of the stream received, such as to suppress image deterioration.

According to preferred modes, if, in distributing a stream in an environment with variable network statuses, it is necessary to convert the stream, it may be converted into a stream corresponding to an upper limit of the terminal's decoding capacity. By so doing, it becomes possible to suppress the load otherwise imposed on the network in converting the stream.

In distributing a stream in an environment of variable network statuses, it may sometimes occur that a stream needs to be converted, but the network bandwidth falls into shortage. In such case, using information from the terminal, according to the present invention, conversion may be made such as to suppress deterioration of image quality.

### Exemplary Embodiment 1

The following describes Exemplary Embodiment 1 of the present invention. FIG. 1 shows a configuration of a moving image delivery system according to Exemplary Embodiment 1 of the present invention. Referring to FIG. 1, a moving image delivery system of Exemplary Embodiment 1 of the present invention includes a delivery server 101, a conversion apparatus 102, a terminal 103 and a transmission path 104 interconnecting the delivery server 101 and the conversion apparatus 102. In addition, the moving image delivery system includes a transmission path 105 interconnecting the terminal 103 and the conversion apparatus 102, and a transmission path 106 interconnecting the delivery server 101 and the terminal 103.

When the encoded data (moving image encoded data) is specified from the terminal 103 over the transmission link 106, the delivery server 101 distributes the encoded data and its encoding information over the transmission link 104 to the conversion apparatus 102.

The conversion apparatus 102 includes a reception unit 107, a capability information exchange unit 108, a moving image transcoder 109 and a transmission/reception unit 110.

The reception unit 107 transmits the encoding information of the encoded data, received from the delivery server 101, to the capability information exchange unit 108. The reception unit 107 also transmits the encoded data, received from the delivery server 101, to the moving image transcoder 109.

The capability information exchange unit 108 exchanges the capability information between it and the terminal 103. The capability information may include, for example,

encoding information;

image size information;

bit rate; and

frame rate.

The encoding information may include, for example,

DCI (Decoder Configuration Information);

SPS (Sequence Parameter Set);

PPS (Picture Parameter Set); and

SEI (Supplemental Enhancement Information).

When notified of the encoding information for the encoded data from the reception unit 107, the capability information exchange unit 108 compares the information against the encoding information notified from the terminal 103 to conclude whether or not to convert the encoded data received from the delivery server 101. In case it is concluded that the conversion is necessary, the capability information exchange unit 108 notifies the moving image transcoder 109 of

image size after the conversion;

bit rate;

frame rate; and

encoding information.

In case the conversion is unnecessary, the capability information exchange unit 108 notifies such effect to the moving image transcoder 109.

When informed of the status of the network by the terminal 103, the capability information exchange unit 108 notifies the moving image transcoder 109 of the image size, bit rate and frame rate following the conversion and the encoding information to the moving image transcoder 109 so that the encoded data will be converted into those fit in with the network status.

As means for informing the network status,

Session Description Protocol (SDP) [RFG (Request For Comments) 2327],

Real Time Streaming Protocol (RTSP) [RFC2326];

RTP Control Protocol (RTCP) [RFC1890]; and

The SIP (Session Initiation Protocol) INFO Method [RFC2976]

may, for example, be used.

If there is no margin in the network bandwidth, the image size, bit rate or the frame rate, for example, may be decreased insofar as such decrease is compatible with the capability information notified from the terminal 103.

If conversely there is a margin in the network bandwidth, the image size, bit rate or the frame rate may be increased insofar as such increase is compatible with the capability information notified from the terminal 103.

In case the image size, bit rate or the frame rate is changed, the encoding information is notified in-band or out-band from the capability information exchange unit 108 to the terminal 103, as necessary.

As methods for notification of the encoding information, the encoding information is delivered as DCI, SPS, PPS or SEI is introduced during encoding. Or, the encoding information is delivered by say SDP, RTSP, RTCP or SIP INFO Method.

In certain cases, encoding information may need to be notified from the capability information exchange unit 108 of the conversion apparatus 102 to the terminal 103. These cases may include say

the case where image size is converted; and

the case where respective levels of the moving image compression encoding scheme have been notified at the outset and the image size as well as the bit rate and the frame rate exceeds an upper limit of the level as prescribed by the moving image compression encoding scheme.

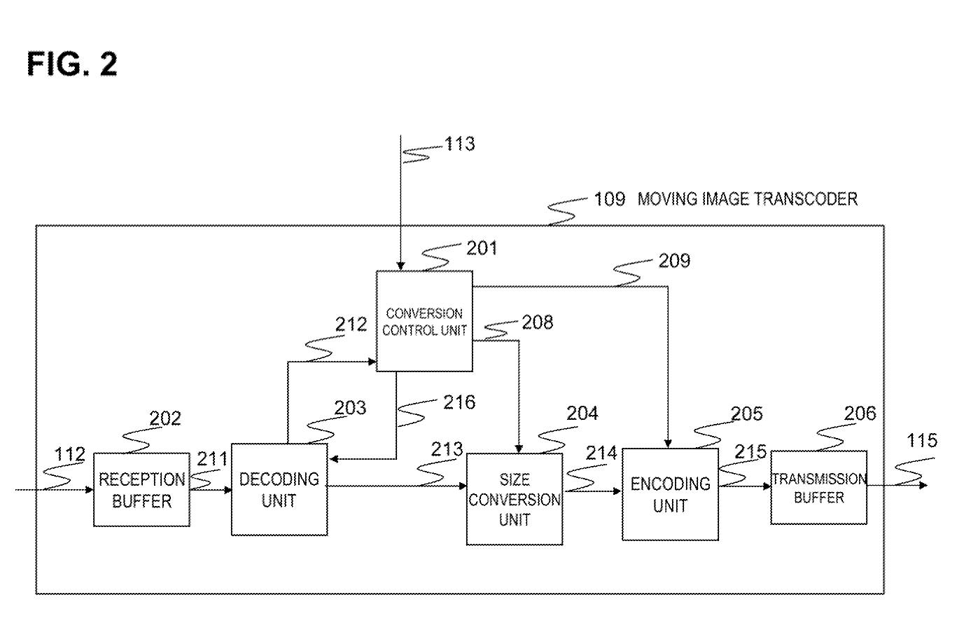

FIG. 2 shows an example configuration of the moving image transcoder 109 of FIG. 1. The flowing describes the moving image transcoder 109 with reference to FIG. 2. The moving image transcoder 109 includes a conversion control unit 201, a reception buffer 202, a decoding unit 203, a size conversion unit 204, an encoding unit 205 and a transmission buffer 206.

The conversion control unit 201 issues a size conversion request 208 to the size conversion unit 204, and conversion information 209 to the encoding unit 205, based upon a conversion request 113 from the capability information exchange unit 108 and upon a set of encoding parameters 212 from the decoding unit 203.

The conversion request 113 may include, for example,

encoding information;

multiplication factor;

image size after the conversion;

bit rate; or

frame rate.

On receipt of the encoding information from the capability information exchange unit 108, the conversion control unit 201 is able to send the encoding information to the decoding unit 203.

The following describes the command 208 from the conversion control unit 201 to the size conversion unit 204. On receipt of the conversion request 113 from the capability information exchange unit 108, the conversion control unit 201 transmits the size conversion request 208 to change the size of the input image data to the size conversion unit 204. In case the conversion request 113 from the capability information exchange unit 108 is a multiplication factor, the conversion request is transmitted unchanged to the size conversion unit 204. When supplied with the image size after conversion from the capability information exchange unit 108, the conversion control unit 201 gets a pre-conversion image size from the encoding parameter set 212 as received from the decoding unit 203, or from the encoding information as received from the capability information exchange unit 108. The conversion control unit 201 then transmits the information regarding the multiplication factor or the input/output image sizes to the size conversion unit 204. If the image size after conversion is the same as the image size before conversion, the conversion control unit 201 commands the size conversion unit 204 not to convert the image size.

The conversion control unit 201 also receives the frame rate information included in the conversion request 113 from the capability information exchange unit 108, and issues a command to the size conversion unit 204. The frame rate information may include

input encoded data;

frame rate information of each of the output encoded data; and

information regarding the number and timing of frames of the input encoded data to be decimated.

The conversion control unit 201 instructs the size conversion unit 204 to decimate frames, based upon the frame rate information.

The following describes a command from the conversion control unit 201 to the encoding unit 205 in detail.

The conversion control unit 201 generates the information 209 to be sent to the encoding unit 205, using the conversion request 113 from the capability information exchange unit 108 and the encoding parameter set 212 from the decoding unit 203.

The information 209 may include, for example,

image data size;

frame type;

prediction mode and direction;

motion vector;

reference frame information;

block size;

block type;

frame type;

bit rate; and

frame rate.

In the case of inter-frame prediction, the following information in the information 209:

frame type;

motion vector;

reference frame information;

block size; and

block type

are used.

In the case of intra-frame prediction, the following information in the information 209:

frame type;

prediction mode and direction;

block size; and

block type

are used.

The sequence of operations for constructing the information 209 using the size conversion request 113 and the set of encoding parameters 212 will now be described.

For simplicity of explanation, the cases of the multiplication factor of 2 and ½ are taken by way of illustration. Of course, these cases are for the sake of explanation of the present invention only and not for limiting the invention. As will be apparent from the principle of the present invention, the cases of using other values of the multiplication factors, motion vector, prediction mode/direction or the block size, may be dealt with in accordance with the present invention.

<Case 1> The Case of Doubling (×2) Image Size

In case a motion vector of an 8×8 block A of input encoded data is five rightwards and four upwards, the information that the size is 16×16 and a motion vector is ten rightwards and eight upwards are supplied to the encoding unit 205, in order to encode the size-converted block A. The values of the reference frame information used at this time are to be the same as those of the input encoded data.

<Case 2> The Case of Halving (×½) Image Size

In case the intra-frame prediction mode in an 8×8 block B of input encoded data is leftward in its direction, the information that the block is sized 4×4 and that the intra-frame prediction mode is leftward in its direction is supplied to the encoding unit 105, in order to encode the size-converted block B.

The following describes the case of changing the frame rate.

The conversion control unit 201 determines whether or not the frame rate is to be dropped, and notifies the encoding unit 205 of whether or not to execute encoding from frame to frame.

Taking an example case of doubling the image size and decimating every other frame, by way of dropping the frame rate, the method of generating a motion vector and the reference frame information will now be described. It should be noted however that, as will be apparent from the principle of the present invention, the size as well as the frame rate different from those given above may also be used.

<Case 1>

Regarding a reference frame, if a frame in question references a frame to be decimated, a past output frame or a frame to be output in future with respect to the frame to be decimated is referenced. Since it is also necessary to decimate the reference frame number, the frame number is decremented a number equal to the number of frames to be decimated. In case the frame in question is referencing a frame to be output, the frame to be output is referenced without being changed. Since it is necessary to decimate the frame number in this case as well, the frame number is decremented a number equal to the number of the frames to be decimated.

Regarding the motion vector, since the image size is doubled, the motion vector of the input encoded data is doubled. If the frame in question is referencing a frame to be output, the motion vector size is to remain equal to a value indicated by the image size ratio.

If a frame in question references a frame to be decimated, a past output frame or a frame to be output in future with respect to the frame being decimated is referenced. If the frame to be decimated is a frame one before the frame in question and a frame two frames before the frame in question, for example, is referenced, the motion vector is doubled from the value indicated by the image size ratio.

For example, if the frame to be decimated is a frame three frames before the frame in question, and a frame two frames before is referenced, the motion vector is to be made equal to 0.66 times a value indicated by the image size ratio.

<Case 2>

Regarding a reference frame, if the frame in question is referencing a frame to be decimated, a frame to be output, referenced by the frame to be decimated, is referenced. Since it is necessary to decimate the reference frame number as well, the frame number is decremented a number equal to the number of the frames to be decimated. In case the frame in question is referencing a frame to be output, the frame to be output is referenced without being changed. Since it is necessary in this case to decimate the reference frame number as well, the frame number is decremented a number equal to the number of the frames to be decimated.

Regarding a motion vector, since the image size is doubled, the motion vector of the input encoded data is doubled. In case the frame in question is referencing a frame to be output, the size of the motion vector is to remain equal to a value indicated by the image size ratio. In case the frame in question is referencing a frame to be decimated, a past output frame or a frame to be output in future with respect to the frame to be decimated is referenced. The motion vector in the input encoded data of the frame in question is summed to the motion vector of the frame to be decimated.

The reception buffer 202 receives the input encoded data 112, sent from the reception unit 107 of FIG. 1, and sends it to the decoding unit 203.

When notified of encoding information 216 from the conversion control unit 201, the decoding unit 203 uses the encoding information 216 to decode image data 213 from the input encoded data 211 received from the reception buffer 202. The decoding unit 203 sends the decoded image data to the size conversion unit 204.

If not notified of encoding information 216 from the conversion control unit 201, the decoding unit 203 uses the encoding information included in the input encoded data 211 to decode image data from the input encoded data 211.

The decoding unit 203 also notifies the conversion control unit 201 of the encoding parameter set 212 for the input encoded data obtained at the time of decoding.

Using the input/output image sizes or the multiplication factor included in the information 208 from the conversion control unit 201, the size conversion unit 204 converts the image size of the image data 213 received from the decoding unit 203. The size conversion unit 204 transmits converted image data 214 to the encoding unit 205.

When requested by the conversion control unit 201 to decimate frames, the size conversion unit 204 discards the image data 213 received from the decoding unit 203 without changing its size. In this case, the image data discarded by the size conversion unit 204 are not sent to the encoding unit 205.

The encoding unit 205 encodes the image data 214, received from the size conversion unit 204, using the information from the conversion control unit 201. The encoding unit 205 sends encoded data 215 to the transmission buffer 206.

If, in case of dropping the frame rate, the encoding unit 205 is instructed by the information from the conversion control unit 201 not to carry out encoding, the encoding unit 205 does not encode the frame in question.

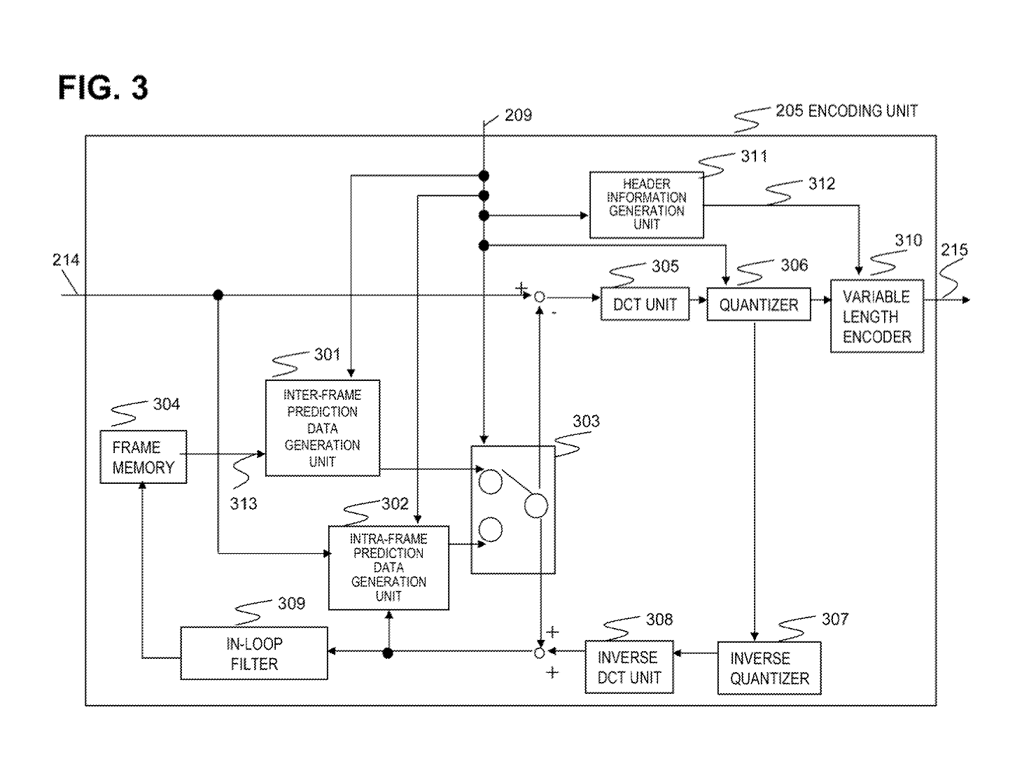

FIG. 3 shows an example configuration of the encoding unit 205 of FIG. 2. The following describes the encoding unit 205 with reference to FIG. 3. Although the present Exemplary Embodiment will be described by taking H.264 as an example, this is only for explanation of the present invention and not for restricting the invention. As will be apparent from the principle of the moving image conversion system of the present invention, H.263, MPEG-4, H.264 SVC (Scalable Video Codec), H.264 MVC (Multiview Video Codec) or other moving image encoding schemes may similarly be dealt with by the present invention.

The encoding unit 205 includes an inter-frame prediction data generation unit 301, an intra-frame prediction data generation unit 302, a switch 303, a frame memory 304, a DCT unit 305, a quantization unit 306, an inverse quantization unit 307, an inverse DCT unit 308, an in-loop filter 309, a variable length encoder 310 and a header information generation unit 311.

The inter-frame prediction data generation unit 301 performs inter-frame prediction, using the information 209 received from the conversion control unit 201 and image data 313 from the frame memory 304 to generate prediction data which are then sent to the switch 303.

The conversion information 209 used in the inter-frame prediction data generation unit 301 may include, for example,

a motion vector;

reference frame information;

block size; and

block type.

Using the information 209 received from the conversion control unit 201, and the image data 214 received from the size conversion unit 204, the intra-frame prediction data generation unit 302 performs intra-frame prediction to generate prediction data which are then forwarded to the switch 303.

The conversion information 209, used in the intra-frame prediction data generation unit 302, may include, for example,

prediction mode and direction;

block size; and

block type.

The switch 303 is changed over, under the conversion information 209 from the conversion control unit 201, to transmit prediction data generated by the inter-frame prediction data generation unit 301 or the intra-frame prediction data generation unit 302 to the DCT unit 305, in-loop filter 309 or to the intra-frame prediction data generation unit 302.

The quantization unit 306 determines a quantization step with the bit rate included in the information 209 indicated by the conversion control unit 201 as a goal. Since the method of determining the quantization step is the same as that in a routine encoding unit, the corresponding description is dispensed with.

Based upon the information 209 received from the conversion control unit 201, the header information generation unit 311 generates header information 312, which is then output to the variable length encoder 310. The information 209, used in the header information generation unit 311 may, for example, be frame type, image size, motion vector, block size, block type, prediction mode/direction, reference frame information or frame rate.

Otherwise, the configuration or operation of FIG. 3 is the same as that in the routine encoding unit, and hence the description is dispensed with.

Referring to FIG. 2, the transmission buffer 206 receives an image stream 215 from the encoding unit 205 to deliver an output image stream 115 to the transmission/reception unit 110 of FIG. 1.

Referring to FIG. 1, the transmission/reception unit 110 notifies the capability information exchange unit 108 of the capability information or the network status as obtained from the terminal 103, while notifying the terminal of the capability information obtained from the capability information exchange unit 108. The transmission/reception unit 110 also transmits the encoded data 115 received from the moving image transcoder to the terminal.

The terminal 103 selects a desired moving image stream to place demand on the delivery server 101 for it. The terminal 103 also exchanges the capability information between it and the conversion apparatus 102, and receives the desired moving image stream from the conversion apparatus 102. The terminal 103 also notifies the conversion apparatus 102 of the status of the network on its own or in response to a request from the conversion apparatus 102.

Among means for notifying the network status, there are

Session Description Protocol (SDP) [RFC2327];

Real Time Streaming Protocol (RTSP) [RFC2326];

RTP Control Protocol (RTCP) [RFC1890]; and

The SIP (Session Initiation Protocol) INFO Method [RFC2976].

The transmission links 104 to 106 are at least one of the circuit exchange network and the packet exchange network.

With the present Exemplary Embodiment, it is possible, in distributing encoded data to a terminal, to expedite the conversion of encoded data of the delivery server in dependence upon the capability information of the terminal or the network status.

The processing in each of the conversion control unit 201, decoding unit 203, size conversion unit 204 and the encoding unit 205 of the moving image transcoder 109 of FIG. 2 may be implemented on a program which is run on a computer of the moving image transcoder 109. In similar manner, the processing in each of the reception unit 107, capability information exchange unit 108, moving image transcoder 109 and the transmission/reception unit 110 in the conversion apparatus 102 of FIG. 1 may be implemented on a program which is run on a computer constituting the conversion apparatus 102.

### Exemplary Embodiment 2

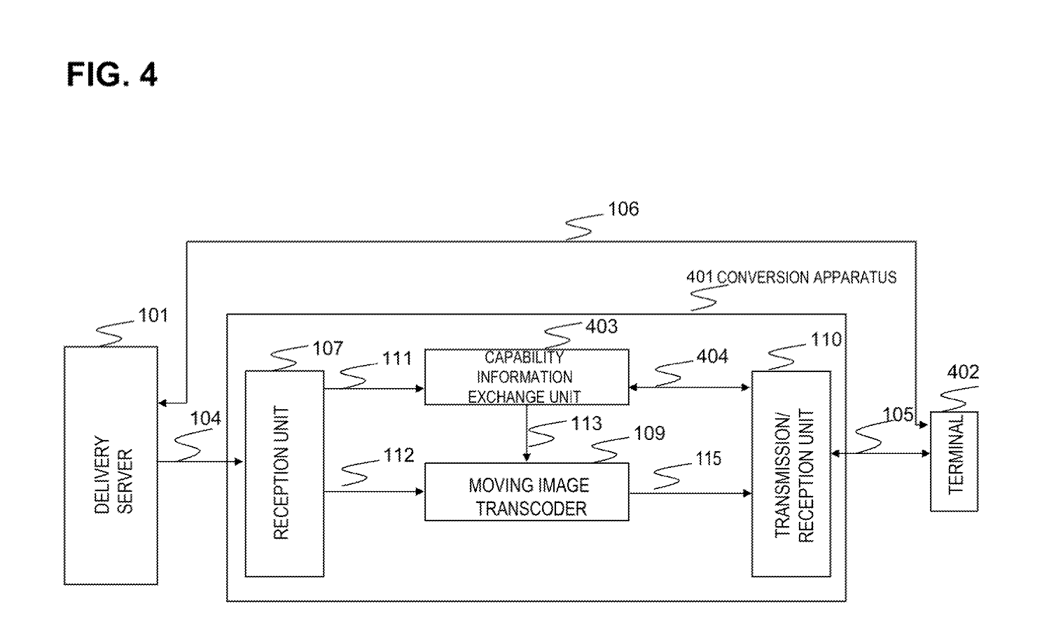

The following described Exemplary Embodiment 2 of the present invention. FIG. 4 shows the configuration of a moving image delivery system according to Exemplary Embodiment 2 of the present invention. In FIG. 4, the same elements as those of FIG. 1 are depicted by the same reference numerals. Referring to FIG. 4, the moving image delivery system includes a delivery server 101, a conversion apparatus 401, a terminal 402 and transmission links 104 to 106.

The conversion apparatus 401 includes a reception unit 107, a capability information exchange unit 403, a moving image transcoder 109 and a transmission/reception unit 110.

The capability information exchange unit 403 exchanges the capability information and the function information between it and the terminal 402. The capability information exchange unit 403 has a network status notified from the terminal 402. In FIG. 4, the capability information, function information and the network information are collectively indicated as information 404.

Among the capability information, there are

encoding information;

image data;

bit rate; and

frame rate.

Among the function information, there are

DCI (Decoder Configuration Information);

SPS (Sequence Parameter Set);

PPS (Picture Parameter Set); and

SEI (Supplemental Enhancement Information).

Among the function information, there are, for example,

function of converting image size;

function of frame interpolation; and

function of expanding stream bandwidth.

Regarding the function of converting image size, there are information on available image size and information on enlargement/reduction ratio. Regarding the function of frame interpolation, there is information on the available amount of frame interpolation. Regarding the function of expanding frame bandwidth, there are information on expanding method and table information for expansion.

In case the terminal 402 has the function of image size conversion, a command is issued to the moving image transcoder 109 to contract image size as well. The terminal 402 enlarges the reduced stream on its own to display the so enlarged stream.

If the terminal 402 has the function of frame interpolation, the moving image transcoder 109 decimates encoded data on a per frame basis. The terminal 402 displays a stream, from decimated encoded data 115, using the frame interpolation function.

In case the terminal 402 has the function of expanding the stream bandwidth, the moving image transcoder 109 enlarges the quantization step to lower the bit rate of the encoded data 115. The terminal 402 enlarges the bandwidth of the encoded data 115 received to display the stream.

In the present Exemplary Embodiment, the above mentioned techniques may be used in combination to execute conversion.

Among means for a terminal to notify the conversion apparatus 401 of the functions, there are

Session Description Protocol (SDP) [RFC2327];

Real Time Streaming Protocol (RTSP) [RFC2326];

RTP Control Protocol (RTCP) [RFC 1890]; and

The SIP (Session Initiation Protocol) INFO Method [RFC2976].

In converting size, frame rate or bit rate, the conversion apparatus 401 may notify, using

Session Description Protocol (SDP) [RFC2327];

Real Time Streaming Protocol (RTSP) [RFC2326];

RTP Control Protocol (RTCP) [RFC1890]; or

The SIP (Session Initiation Protocol) INFO Method [RFC2976].

The terminal 402 notifies its own function information for itself or in response to a request from the conversion apparatus 401. Among the function information, there are, for example, the information on the function of changing the image size, the function of frame interpolation and the function of stream bandwidth expansion. Otherwise, the configuration and operation are the same as those of Exemplary Embodiment 1, and hence the corresponding description is dispensed with.

In the present Exemplary Embodiment, in distributing encoded data to the terminal, the encoded data of the delivery server 101 may speedily be converted in response to the terminal capability information or the network status. On the other hand, the function information may be used to suppress deterioration of the image quality as compared to Exemplary Embodiment 1. In the present Exemplary Embodiment, the functions of respective parts of the conversion apparatus 401 may naturally be implemented on a program which is run on a computer of conversion apparatus 401.

### Exemplary Embodiment 3

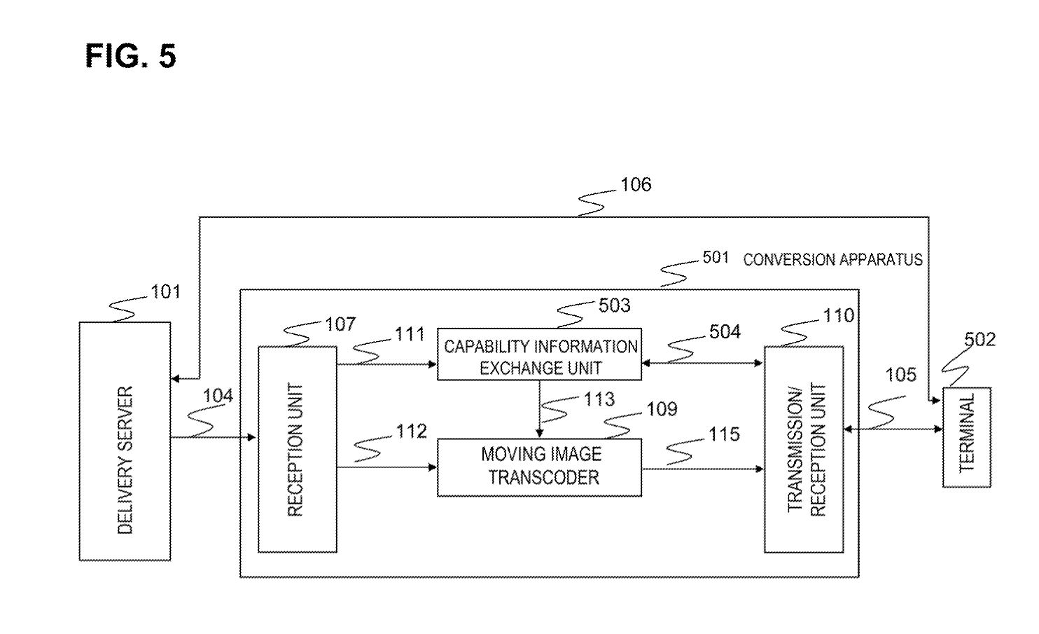

The following describes Exemplary Embodiment 3 of the present invention in detail with reference to Referring to FIGS. 2, 3 and 5. FIG. 5 shows the configuration of a moving image delivery system of Exemplary Embodiment 3 of the present invention. In FIG. 5, the same elements as those of FIG. 1 are depicted by the same reference numerals. Referring to FIG. 5, the moving image delivery system includes a delivery server 101, a conversion apparatus 501, a terminal 502 and transmission links 104 to 106.

The conversion apparatus 501 includes a reception unit 107, a capability information exchange unit 503, a moving image transcoder 109 and a transmission/reception unit 110.

The capability information exchange unit 503 exchanges the capability information, function information and the subscriber information between it and the terminal 502. The capability information exchange unit 503 also has the terminal 502 notify the network status. In FIG. 5, the capability information, subscriber information and the network information are combined together and the information resulting from the combination is represented as information 504.

The subscriber information may include

information indicating whether or not a communication is through a dedicated network inclusive of a femto-cell or small-sized base station;

information indicating whether or not utilization is under a fixed fee contract; and

information on an operator under contract.

The subscriber information may be notified, using

Session Description Protocol (SDP) [RFC2327];

Real Time Streaming Protocol (RTSP) [RFC2326];

RTP Control Protocol (RTCP) [RFC 1890]; or

The SIP (Session Initiation Protocol) INFO Method [RFC2976].

The capability information exchange unit 503 of the conversion apparatus 501 converts the input encoded data based upon the capability information, function information and the subscriber information, or upon the capability information, network status and the function information.

For example, if the terminal 502 receives the encoded data without exploiting a dedicated network, the conversion apparatus 501 suppresses the bit rate within the range of the capability information based upon the function information owned by the terminal 502.

In case the terminal 502 has the function of converting image size, the image size is reduced within the conversion apparatus 501.

In case the terminal 502 has the function of interpolating a frame(s), the frame is decimated within the conversion apparatus 501.

In case the terminal 502 has the function of expanding the stream bandwidth, the bit rate is suppressed within the conversion apparatus 501.

For example, in case the terminal 502 receives encoded data using a dedicated network, the encoded data is not converted. Or, at least one of

image size enlargement;

frame rate interpolation; and

expansion of bandwidth of stream

is executed in the conversion apparatus 501 within the rage of the capability information to distribute the encoded data to the terminal 502.

Also, in case the terminal 502 receives the encoded data with the use of the fixed rate system, the conversion apparatus 501 suppresses the bit rate, within the range of the capability information, based upon the function information owned by the terminal 502.

In case the terminal 502 has the function of image size conversion, the image size is reduced within the conversion apparatus 501.

In case the terminal 502 has the function of frame interpolation, the frame is decimated within the conversion apparatus 501.

In case the terminal 502 has the function of expanding stream bandwidth, the bit rate is suppressed within the conversion apparatus 501.

For example, in case the terminal 502 receives encoded data using a dedicated network, the encoded data may not be converted. Or, at least one of

enlarging image size;

interpolating frame rate; and

expanding stream bandwidth

may be performed within the conversion apparatus 501 to distribute the encoded data to the terminal 502.

Services/bandwidths contracted with an operator are combined with the terminal's own function information, based upon the operator information, to perform the same conversion as that described above.

The terminal 502 notifies the conversion apparatus 501 of the own function information or the subscriber information on its own or responsive to a request from the conversion apparatus 501. The configuration and the operation other than those described above are the same as in Exemplary Embodiments 1 and 2 and hence the corresponding description is dispensed with.

With the present Exemplary Embodiment, in distributing the encoded data to the terminal, the encoded data of the delivery server may speedily be converted in dependence upon terminal's capability information or the network status. In addition, band allocation to the subscribers may be controlled more readily than in the above Exemplary Embodiments 1 and 2. It should be observed that, in the present Exemplary Embodiment, the functions of various components of the conversion apparatus 501 may naturally be implemented by a program which is run on a computer of the conversion apparatus 501.

### Exemplary Embodiment 4

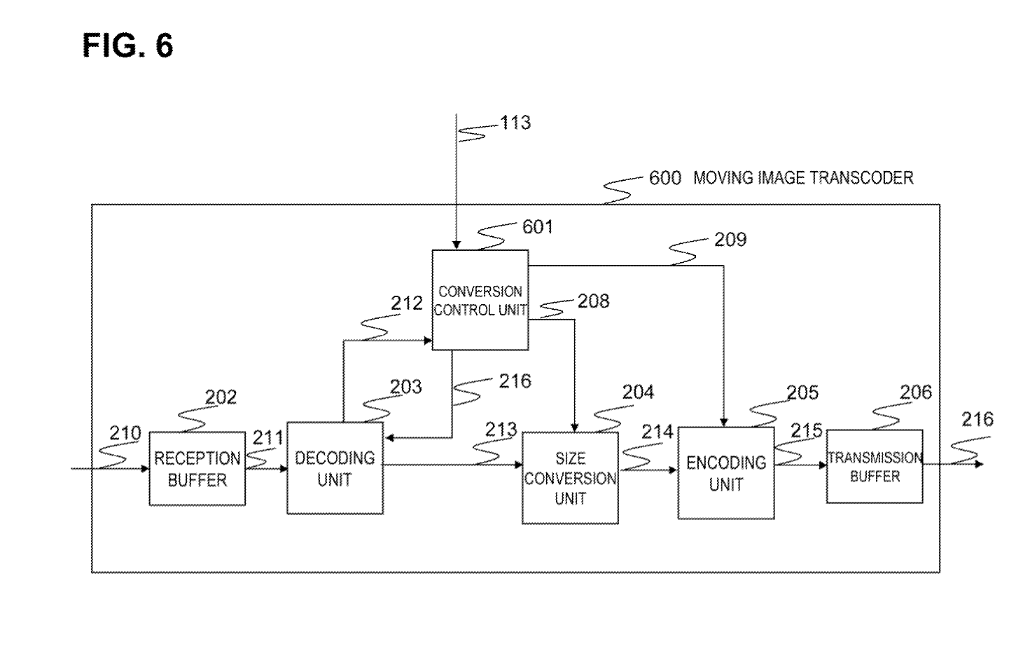

The following describes Exemplary Embodiment 4 of the present invention in detail with reference to FIGS. 1, 3 and 6. FIG. 6 shows a configuration of a moving image transcoder 600 of Exemplary Embodiment 4 of the present invention. In FIG. 6, the elements which are the same as or equivalent to those of FIG. 2 are depicted by the same reference numerals. The moving image transcoder 600 is arranged at a position of the moving image transcoder 109 of FIGS. 1, 4 and 5.

Referring to FIG. 6, a conversion apparatus 601 sends a size conversion request 208 to a size conversion unit 204, and sends conversion information 209 to the encoding unit 205, based upon a conversion request 113 from a capability information exchange unit 108 (403, 503) (see FIGS. 1, 4 and 5).

The sequence of operations for constructing the conversion information 209 using the conversion request 113 and an encoding parameter set 212 will now be described. Although the case of quadrupling the image size is taken for simplicity, any multiplication factor other than four may naturally be used.

### <Case 1> Case of Quadrupling (×4) Image Size

In case the intra-frame prediction mode of a 4×4 block B of input encoded data is left upward direction, with an angle of 30°, the size is set to 16×16 to encode the block B after conversion. If there is no left upward direction, with the angle of 30°, in the intra-frame prediction mode of the 16×16 block, approximation is made to an existing prediction direction. For example, if there are only four directions of leftward, rightward, upward and downward directions, the information for the leftward direction is sent to the encoding unit 205.

The configuration and operation other than those described above are the same as those of Exemplary Embodiments 1 and 3, and hence the corresponding description is dispensed with.

With the present Exemplary Embodiment, in distributing encoded data to a terminal, it is possible to execute speedy conversion in dependence upon capability information of the terminal and the network status. Moreover, with the present Exemplary Embodiment, it is possible to improve flexibility in size conversion. In the present Exemplary Embodiment, the functions of various components of the moving image transcoder 600 may be implemented on a program which is run on a computer of the moving image transcoder 600.

### Exemplary Embodiment 5

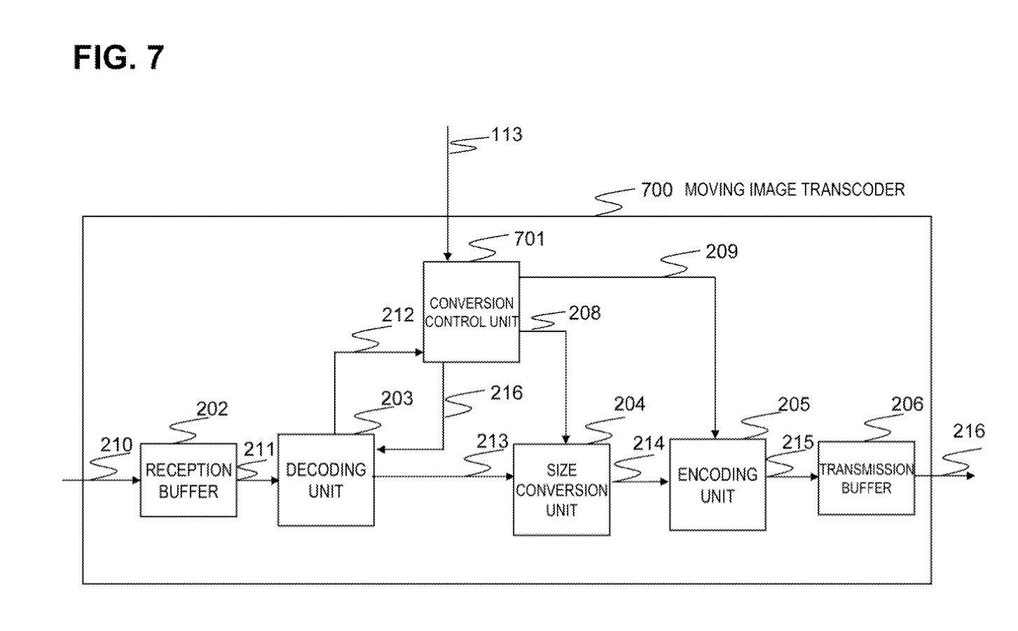

The following describes Exemplary Embodiment 5 of the present invention in detail with reference to FIGS. 1, 3 and 7. FIG. 7 shows a configuration of a moving image transcoder 700 of Exemplary Embodiment 5 of the present invention. In FIG. 7, the elements which are the same as or equivalent to those of FIG. 2 are depicted by the same reference numerals. The moving image transcoder 700 is arranged at a position of the moving image transcoder 109 of FIGS. 1, 4 and 5.

Referring to FIG. 7, a conversion apparatus 701 transmits a size conversion request 208 to a size conversion unit 204, while transmitting conversion information 209 to an encoding unit 205, based upon a conversion request 113 from a capability information exchange unit 108 and an encoding parameter set 212 from a decoding unit 203.

The sequence of operations for constructing the conversion information 209 using the conversion request 113 and the encoding parameter set 212 will now be described. Although the cases of doubling (×2) and halving (×½) the image size are taken for simplicity, those cases are given only for illustration and not for restriction of the present invention. As will be apparent from the principle of the present invention, the cases of using other values of the multiplication factor for image size change or of changing the motion vector, prediction modes or directions or the block size may be dealt with by the present invention.

### <Case 1> The Case of Doubling (×2) Image Size

In case the motion vector of the 16×16 block A of the input encoded data is five rightwards and four upwards, the block A following the size conversion is sized 32×32. If assumed that the maximum unit size of the block being encoded is 16×16, it is necessary to split the 32×32 block A after conversion into four equal sections. At this time, the motion vector of ten rightwards and eight upwards for each of the resulting four 16×16 blocks is sent to the encoding unit 205. The same values as the input encoded data are used at this time for the reference frame information.

<Case 2> Case of Halving (×½) Image Size

In case the intra-frame prediction mode for the 4×4 block B of the input encoded data is the leftward direction, the block B following the size conversion is sized 2×2. If the minimum size unit of the block being encoded is 4×4, it is necessary to provide the 4×4 sized block by combining the 2×2 block B after size conversion with neighboring 2×2 blocks in order to allow for encoding. In this case, the prediction modes and directions of the 2×2 blocks are combined together to decide on a single prediction mode.

As methods for synthesis, the most prevalent ones of the four modes and directions are supplied to the encoding unit 205. If two of the four 2×2 blocks are leftwards and the remaining two are upwards, and there is a 45° direction mode, a 45° left upward direction mode is selected. If the four 2×2 blocks are leftwards, rightwards, upwards and downwards, a mean value mode is used.

Otherwise, the configuration and operation are the same as in Exemplary Embodiments 1 and 3, and hence the corresponding description is dispensed with. In the present Exemplary Embodiment, when the encoded data of the delivery server are distributed to a terminal, the encoded data may speedily be converted in dependence upon the network status, while flexibility in size conversion may be higher than in Exemplary Embodiment 3. In the present Exemplary Embodiment, the functions of respective components of the moving image transcoder 700 may naturally be implemented by a program which is run on a computer of the moving image transcoder 700.

### Exemplary Embodiment 6

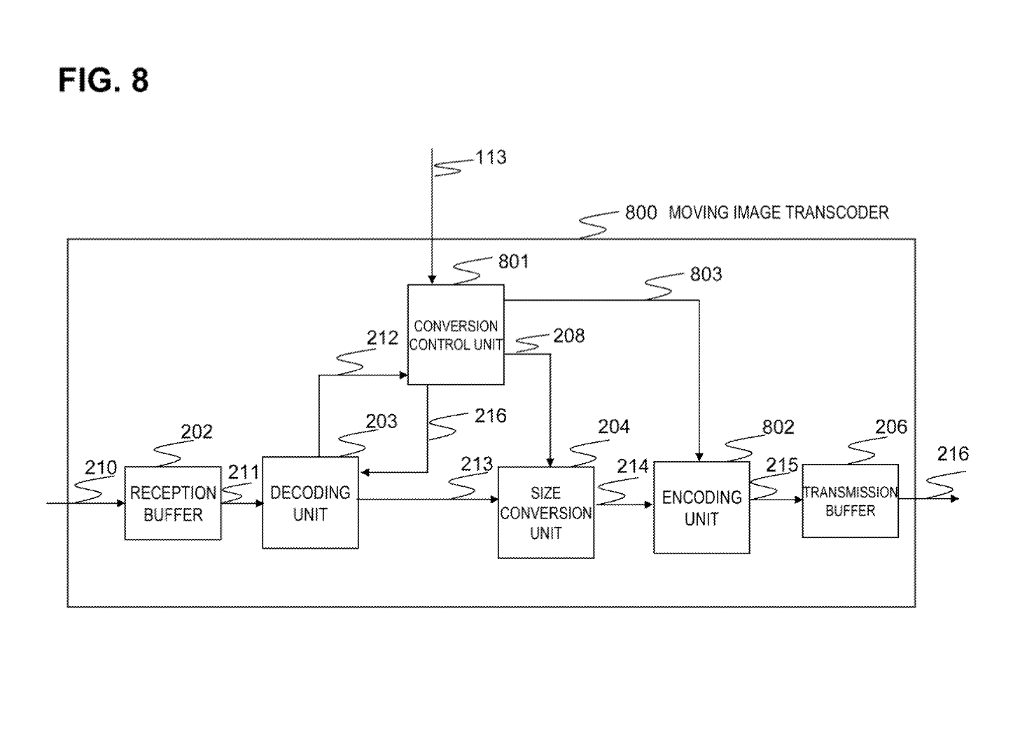

The following describes Exemplary Embodiment 6 of the present invention in detail with reference to FIGS. 1, 8 and 9. FIG. 8 shows a configuration of a moving image transcoder 800 of Exemplary Embodiment 6 of the present invention. In FIG. 8, the elements which are the same as or equivalent to those of FIG. 2 are depicted by the same reference numerals. The moving image transcoder 800 is arranged at a position of the moving image transcoder 109 of FIGS. 1, 4 and 5.

Referring to FIG. 8, a conversion control unit 801 sends a size conversion request 208 to a size conversion unit 204, and sends conversion information 803 to an encoding unit 802, based upon a conversion request 113 from a capability information exchange unit 108 and an encoding parameter set 212 from a decoding unit 203.

The conversion control unit 801 sends

image data size;

frame type;

prediction mode and direction;

motion vector;

reference frame information;

block size;

block type;

bit rate; and

frame rate

to the encoding unit 802.

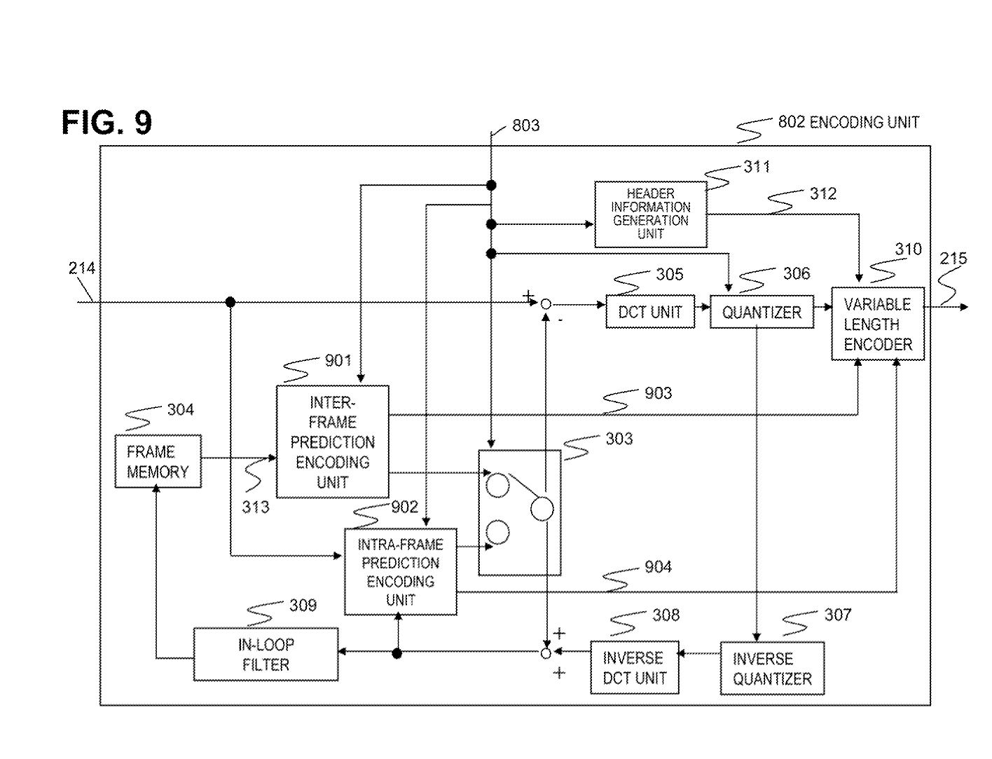

FIG. 9 shows a configuration of the encoding unit 802 of Exemplary Embodiment 6 of the present invention. In FIG. 9, the elements which are the same as or equivalent to those of FIG. 3 are depicted by the same reference numerals. Referring to FIG. 9, the encoding unit 802 will be described.

An inter-frame prediction encoding unit 901 performs inter-frame prediction encoding using the conversion information 803 received from a conversion control unit 801.

More specifically, the inter-frame prediction encoding unit 901 receives, as the conversion information 803,

reference frame information;

motion vector;

frame search range; and

motion vector search range.

On receipt of image data of one frame of image data from a frame memory 904, the inter-frame prediction encoding unit 901 performs inter-frame prediction on the one frame of image data, just within a motion vector search range, using the motion vector as start point or as reference.

As regards a search range, the inter-frame prediction encoding unit 901 performs search, from the motion vector as start point, as far as points evenly spaced apart a preset distance upwards, downwards, leftwards and rightwards. Or, the inter-frame prediction encoding unit 901 performs search by exploiting the motion vector direction, that is, just in the direction of the motion vector, as far as points spaced apart a preset distance from the motion vector as start point. If the frame search range is over two frames, motion vector search is carried out for the frame search range, with the frame number as start point, to decide on an optimum motion vector and an optimum frame number. The optimum motion vector and frame number are transmitted as being the reference frame information 903 to a variable length encoder 310.

An intra-frame prediction encoding unit 902 uses the conversion information 803 received from the conversion control unit 801 to execute intra-frame prediction encoding. In more concrete terms, the intra-frame prediction encoding unit 902 receives, as the conversion information 803,

prediction mode; and

search range.

On receipt of a block for prediction and near-by pixel data, the intra-frame prediction encoding unit 902 decides on an optimum prediction mode, out of the prediction modes of the search range, with the received prediction mode as start point. The intra-frame prediction encoding unit 902 sends the optimum prediction mode, thus decided on, to the variable length encoder 310 as prediction mode 904.

The following describes an example method of searching with the prediction mode received in the conversion information 803 as start point.

It is supposed that there are prediction directions every 45°, and

the prediction mode, received from the information 803, is leftward direction, and that

the search range is two.

In such case, intra-frame prediction is executed not only leftwards but also 45° in the upper leftward direction and 45° lower leftward direction to decide on an optimum prediction mode.

Otherwise, the configuration and the operation are the same as those of Exemplary Embodiments 1 and 4, and hence are not explained. With the present Exemplary Embodiment, in distributing encoded data to a terminal, the encoded data of a delivery server may speedily be converted in dependence upon the information on the terminal's capability and the network status. Moreover, in the present Exemplary Embodiment, the image quality may be made higher than in Exemplary Embodiments 1 to 4. It is observed that, with the present Exemplary Embodiment, the functions of various components of the moving image transcoder 800 may be implemented on a program which is run on a computer of the moving image transcoder 800.

### Exemplary Embodiment 7

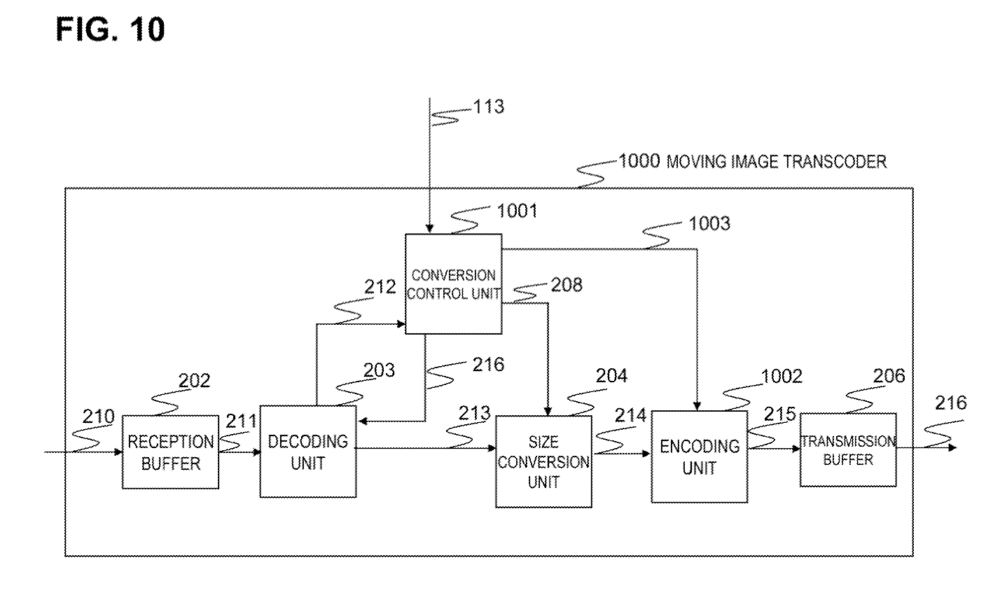

The following describes Exemplary Embodiment 7 of the present invention in detail with reference to Referring to FIGS. 1, 10 and 11. FIG. 10 shows a configuration of a moving image transcoder 1000 of Exemplary Embodiment 7 of the present invention. In FIG. 10, the elements which are the same as or equivalent to those of FIG. 2 are depicted by the same reference numerals. The moving image transcoder 1000 is arranged at a position of the moving image transcoder 109 of FIGS. 1, 4 and 5.

Referring to FIG. 10, a conversion control unit 1001 sends a size conversion request 208 to a size conversion unit 204, and sends a command to an encoding unit 1002, based upon a conversion request 113 from a capability information exchange unit 108 (403, 503) (see FIGS. 1, 4 and 5) and an encoding parameter set 212 from a decoding unit 203.

The conversion control unit 1001 sends, to an encoding unit 1002,

image data size; and

threshold value (information 1003) used in determining whether or not to use a frame type, prediction mode and direction, motion vector, reference frame information, block size, block type, frame rate, code amount delivery of input encoded data, bit rate, prediction mode or a motion vector.

The threshold value may, for example, be (the size of a block predicted)×(a mean value of amplitudes of image data or, a square thereof), or

a target code amount in each block as calculated from the code amount delivery of the input encoded data or the bit rate.

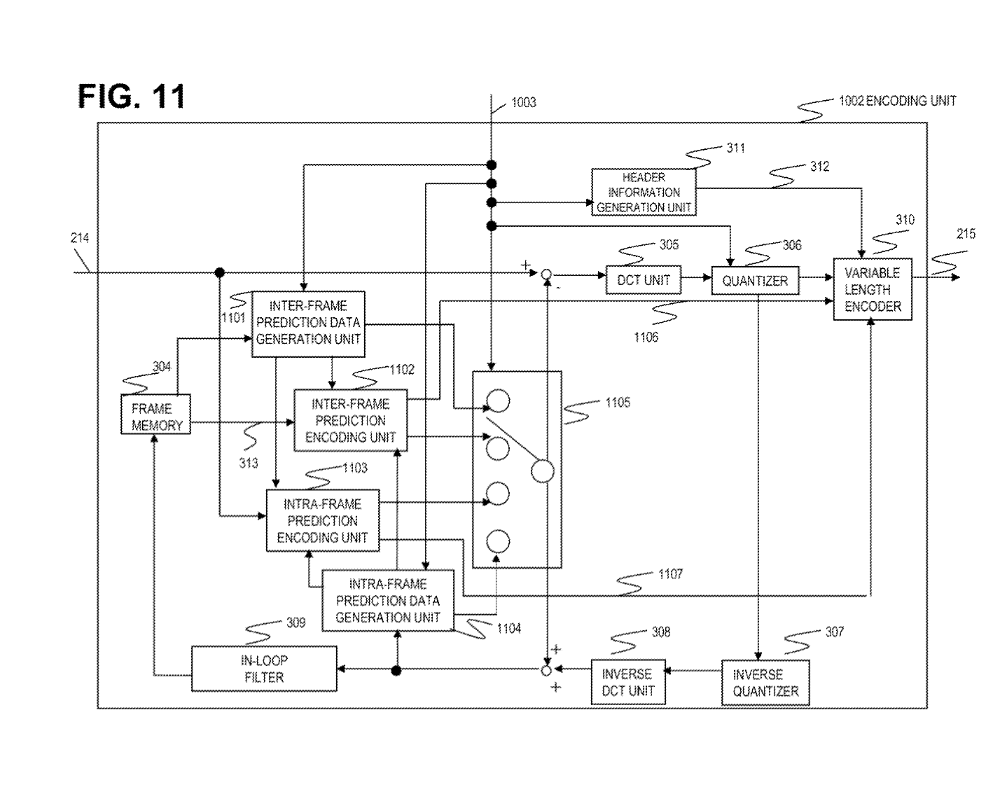

FIG. 11 shows a configuration of the encoding unit 1002 of Exemplary Embodiment 7 of the present invention. In FIG. 11, the elements which are the same as or equivalent to those of FIG. 3 are indicated by the same reference numerals. The encoding unit 1002 will now be described with reference to FIG. 10.

An inter-frame prediction data generation unit 1101 generates inter-frame prediction data, using the motion vector and the frame number contained in conversion information 1003 received from the conversion control unit 1001. The difference between the inter-frame prediction data and the image data of the frame memory 304 is compared with its threshold value.

In case the prediction residual is smaller than the threshold value, an inter-frame prediction encoding unit 1102 adopts the motion vector and the frame number received in conversion information 1003.

In case the prediction residual is larger than the threshold value, the inter-frame prediction encoding unit 1102 performs inter-frame prediction to decide on a motion vector and a frame number. The motion vector and reference frame information 1106 are transmitted to a variable length encoder 310. The inter-frame prediction encoding unit 1102 may at this time use the motion vector and the frame number, received with the conversion information 1003, as start point.

An intra-frame prediction encoding unit 1103 may be used at this time in place of the inter-frame prediction encoding unit 1102.

An intra-frame prediction data generation unit 1104 uses the prediction mode, received in the information 1003, to generate intra-frame prediction data. The intra-frame prediction data generation unit 1104 compares a difference between the intra-frame prediction data and image data in the vicinity of a block of interest with a threshold value.

In case the prediction residual is smaller than the threshold value, the intra-frame prediction data generation unit 1104 adopts the prediction mode received in the conversion information 1003.

In case the prediction residual is larger than the threshold value, the intra-frame prediction encoding unit 1103 performs intra-frame prediction to decide on a prediction mode (1107) which is sent to the variable length encoder 310. The prediction mode received in the conversion information 1003 may then be used as start point. The inter-frame prediction encoding unit 1102 may be used in place of the intra-frame prediction encoding unit 1103.

Otherwise, the configuration and the operation are the same as those of Exemplary Embodiments 1 to 6, and hence the corresponding description is dispensed with. In the present Exemplary Embodiment, in distributing encoded data to a terminal, encoded data of the delivery server may speedily be converted in dependence upon the information on the terminal's capability or on the network status. Moreover, the image quality may be improved over that of Exemplary Embodiments 1 to 6. In the present Exemplary Embodiment, the functions of respective components of the moving image transcoder 1000 may naturally be implemented on a program which is run on a computer of the moving image transcoder 1000.

### Exemplary Embodiment 8

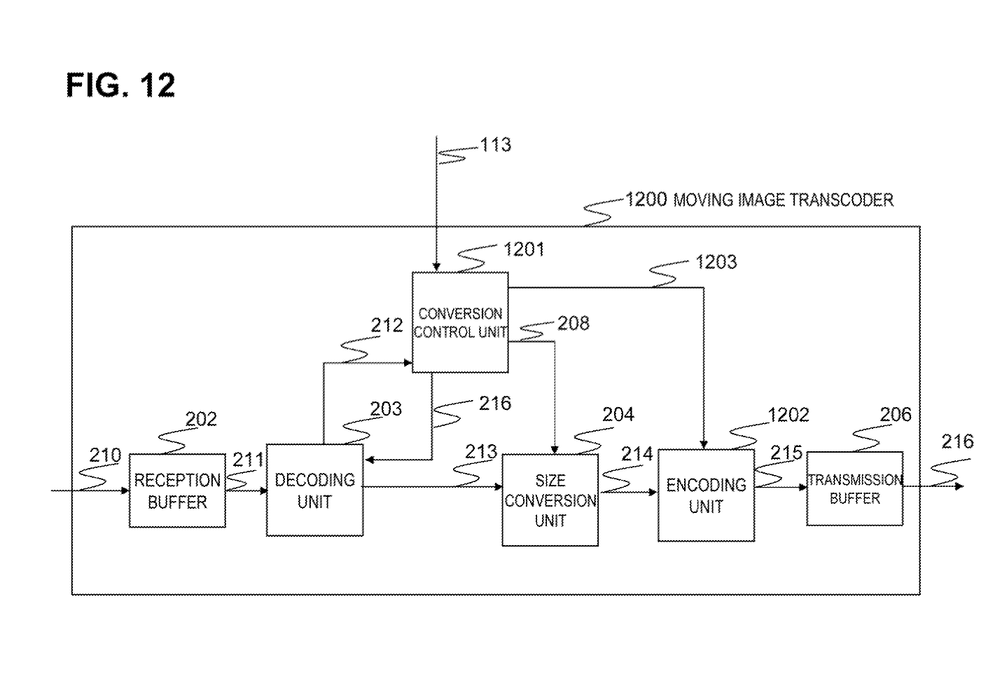

The following describes Exemplary Embodiment 8 of the present invention in detail with reference to FIGS. 1, 12 and 13. FIG. 12 shows a configuration of a moving image transcoder 1200 of Exemplary Embodiment 8 of the present invention. In FIG. 12, the elements which are the same as or equivalent to those of FIG. 2 are depicted by the same reference numerals. The moving image transcoder 1200 is arranged at a position of the moving image transcoder 109 of FIGS. 1, 4 and 5.

Referring to FIG. 12, a conversion control unit 1201 sends a size conversion request 208 to a size conversion unit 204, and sends conversion information 1203 to an encoding unit 1202, based upon a conversion request 113 from a capability information exchange unit 108 (403, 503) (see FIGS. 1, 4 and 5) and an encoding parameter set 212 from a decoding unit 203.

The conversion control unit 1201 sends, to the encoding unit 1202,

image data size;

frame type;

prediction mode and direction;

motion vector;

reference frame information;

block size;

block type;

frame rate; and

quantization step size

as the conversion information 1203.

The conversion control unit 1201 compares at least one of the image data size and the bit rate included in the conversion request 113 from the capability information exchange unit 108 (403, 503) (see FIGS. 1, 4 and 5) with the corresponding information before conversion to render it possible to convert the quantization step size to N or 1/N times that of the pre-conversion information.

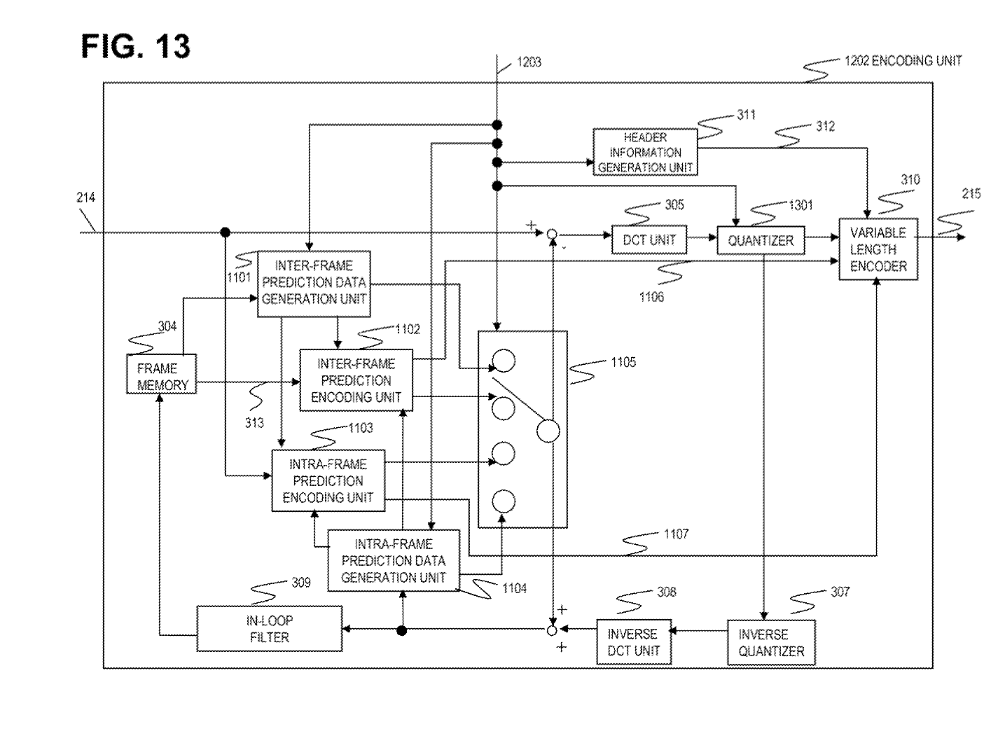

FIG. 13 shows a configuration of the encoding unit 1202 of Exemplary Embodiment 8 of the present invention. In FIG. 13, the same elements as those of FIG. 11 are indicated by the same reference numerals. The encoding unit 1202 will now be described in detail with reference to FIG. 13.

Referring to FIG. 13, a quantization unit 1301 performs quantization using the quantization step size contained in the conversion information 1203 received from the conversion control unit 1201.

Otherwise, the configuration and the operation are the same as in Exemplary Embodiments 1 to 7 and hence the corresponding description is dispensed with.

In the present Exemplary Embodiment, in distributing encoded data of a delivery server to a terminal, the encoded data may be converted more speedily than in Exemplary Embodiments 1 to 7 depending upon the information on the terminal's capability or on the network status. In the present Exemplary Embodiment, various functions of respective parts of the moving image transcoder 1200 may naturally be implemented by a program which is run on a computer of the moving image transcoder 1200.

### Exemplary Embodiment 9

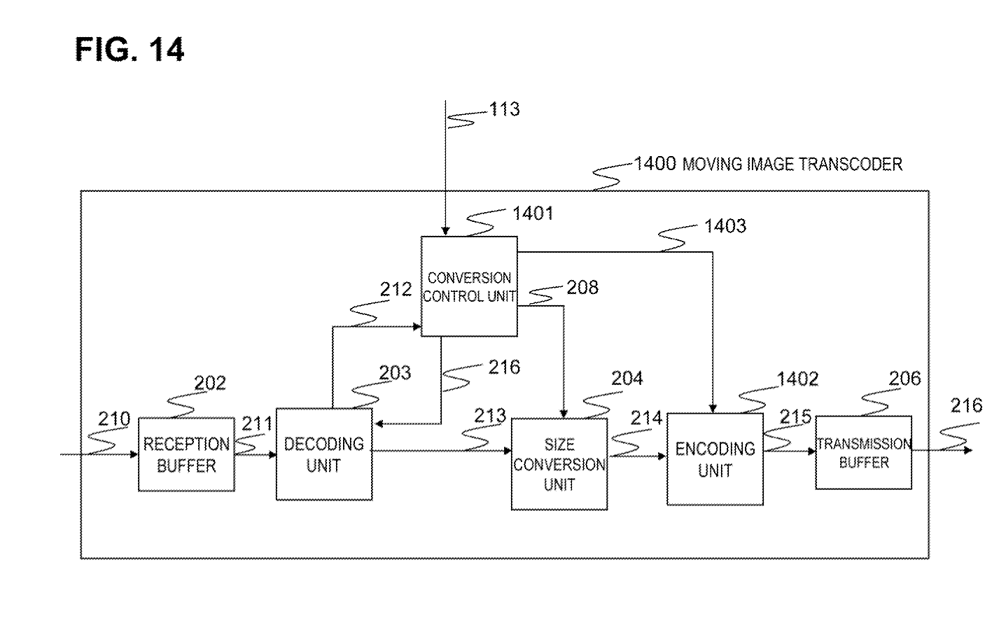

The following describes Exemplary Embodiment 9 of the present invention with reference to FIGS. 1, 14 and 15. FIG. 14 shows a configuration of a moving image transcoder 1400 of Exemplary Embodiment 9 of the present invention. In FIG. 14, the elements which are the same as or equivalent to those of FIG. 2 are depicted by the same reference numerals. The moving image transcoder 1400 is arranged at a position of the moving image transcoder 109 of FIGS. 1, 4 and 5.

Referring to FIG. 14, a conversion control unit 1401 sends a size conversion request 208 to a size conversion unit 204, while transmitting a conversion information command to an encoding unit 1402, based upon a conversion request 113 from a capability information exchange unit 108 (403, 503) (see FIGS. 1, 4 and 5) and an encoding parameter set 212 from a decoding unit 203.

The conversion control unit 1401 sends, as conversion information 1403,

image data size;

frame type;

prediction mode and direction;

motion vector;

reference frame information;

block size;

block type;

frame rate;

bit rate; and

code amount delivery of input encoded data

to the encoding unit 1402.

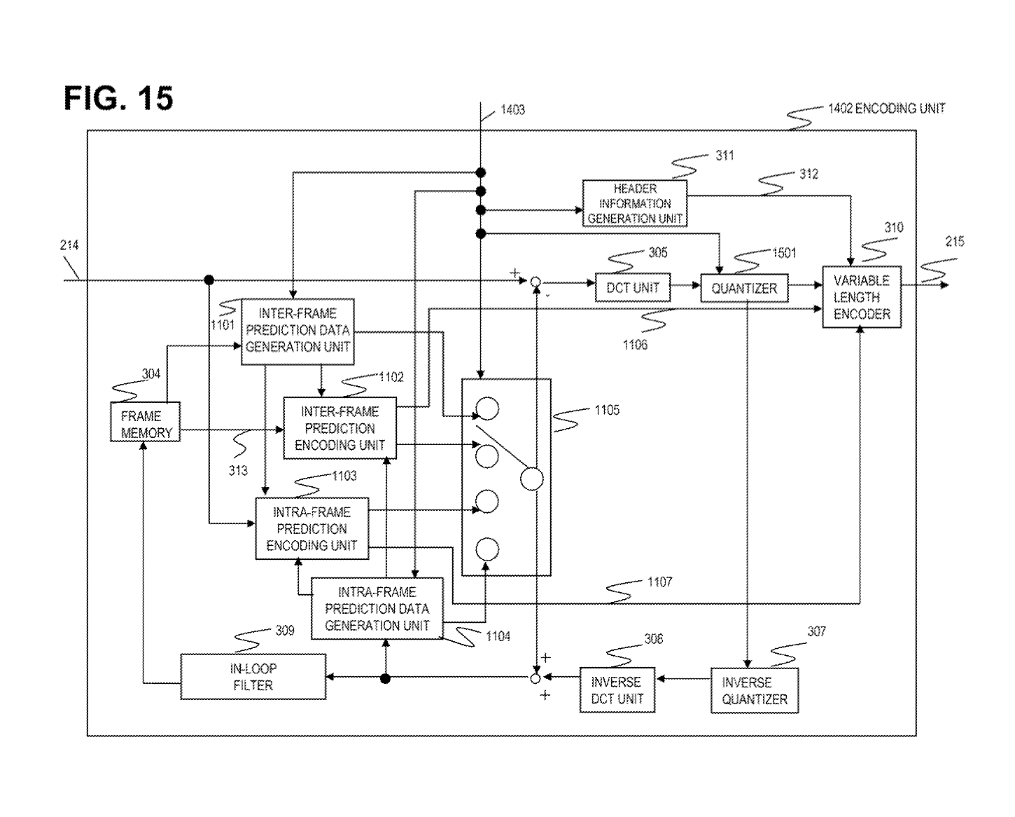

FIG. 15 shows a configuration of the encoding unit 1402 of Exemplary Embodiment 9 of the present invention. In FIG. 15, the parts which are the same as or equivalent to those of FIG. 11 are depicted by the same reference numerals. The encoding unit 1402 will now be described in detail with reference to FIG. 15.

A quantization unit 1501 decides on a target code amount of each block, using the code amount delivery of the input encoded data and the bit rate contained in conversion information 1403 received from the conversion control unit 1401. The quantization unit 1501 also decides on the quantization step size to execute quantization.

Otherwise, the configuration and the operation are the same as those of Exemplary Embodiments 1 to 8 and hence are not explained.

In the present Exemplary Embodiment, in converting image size of the input encoded data, the code amount may be adjusted more satisfactorily than in Exemplary Embodiments 1 to 8. Meanwhile, in the present Exemplary Embodiment, the functions of respective components of the moving image transcoder 1400 may naturally be implemented by a program which is run on a computer of the moving image transcoder 1400.

### Exemplary Embodiment 10

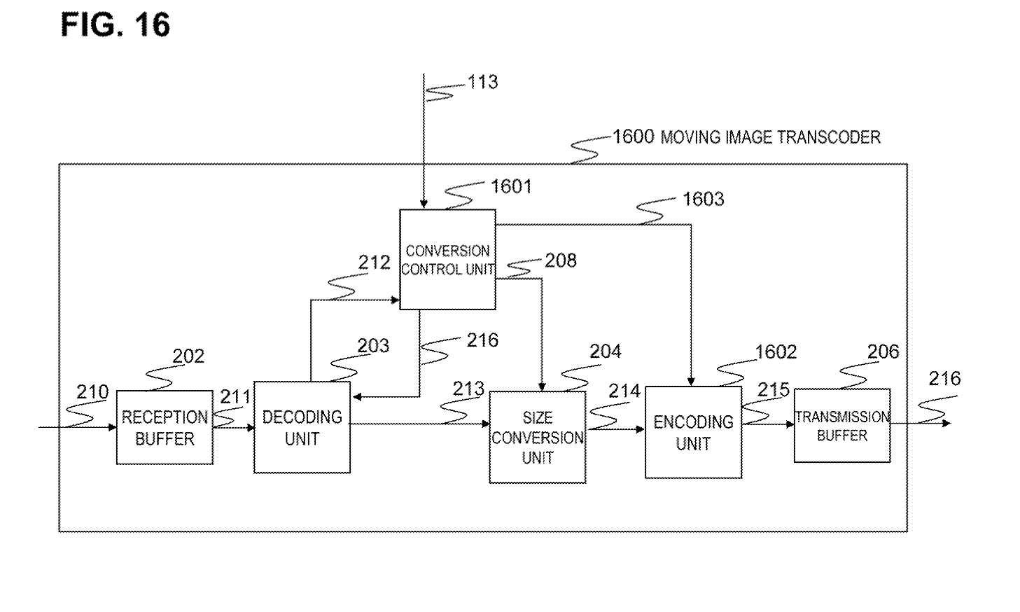

The following describes Exemplary Embodiment 10 of the present invention in detail with reference to FIGS. 1, 16 and 17. FIG. 16 shows a configuration of a moving image transcoder 1600 of Exemplary Embodiment 10 of the present invention. In FIG. 16, the elements which are the same as or equivalent to those of FIG. 2 are depicted by the same reference numerals. The moving image transcoder 1600 is arranged at a position of the moving image transcoder 109 of FIGS. 1, 4 and 5.

Referring to FIG. 16, a conversion control unit 1601 sends a size conversion request 208 to a size conversion unit 204, while transmitting conversion information 1603 to an encoding unit 1602, based upon a conversion request 113 from a capability information exchange unit 108 (403, 503) (see FIGS. 1, 4 and 5) and an encoding parameter set 212 from a decoding unit 203.

The conversion control unit 1601 sends, as conversion information 1603,

image data size;

frame type;

prediction mode and direction;

motion vector;

reference frame information;

block size;

block type;

bit rate;

frame rate; and

quantization information

to the encoding unit 1602.

The quantization information may include

quantization step size of input encoded data;

whether or not code amount delivery of the input encoded data is to be used;

quantization step size; and

bit rate.

In giving a decision on whether or not to use the quantization step size of the input encoded data, the following are not used, for example,

case in which of a size conversion ratio is of a large value;

case in which a bit rate ratio between bit rate of input encoded data and bit rate of output encoded data is of a large value; or

case in which increase or decrease of the size conversion ratio differs significantly from increase or decrease of the input/output bit rate ratio

In giving a decision on whether or not to use the code amount delivery of the input encoded data, the following is not used, for example,

case in which a difference between the target bit rate and the output code amount is large.

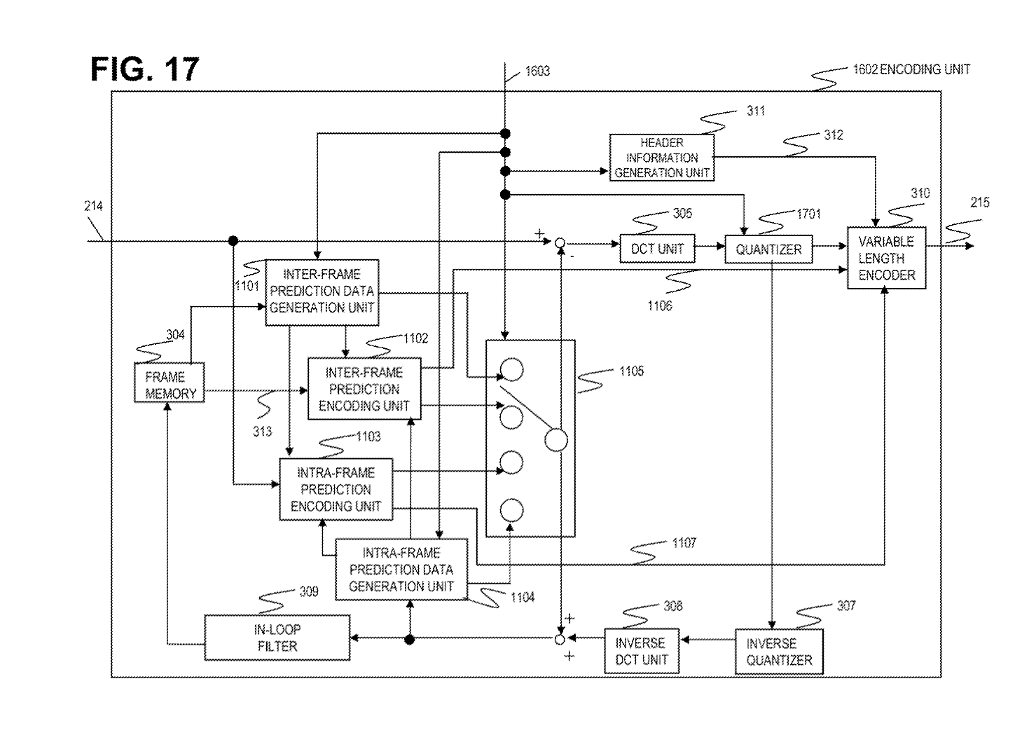

FIG. 17 shows a configuration of the encoding unit 1602 in Exemplary Embodiment 10 of the present invention. In FIG. 17, the parts which are the same as or equivalent to those shown in FIG. 11 are depicted by the same reference numerals. The encoding unit 1602 will now be described in detail with reference to FIG. 17.

A quantization unit 1701 performs quantization using the information included in the conversion information 1603 received from the conversion control unit 1601. Such information in the conversion information may include information on whether or not to use the code amount delivery or the quantization step size of the input encoded data. The quantization unit 1701 may also perform quantization using the quantization step size, code amount delivery or bit rate.

Specifically, based on the information on whether or not to use the code amount delivery or the quantization step size of the input encoded data, in case the information is used, the quantization unit 1701 performs quantization using the above mentioned quantization step size of the input encoded data or the quantization step size calculated using the code amount delivery. In case the information of the code amount delivery or the quantization step size of the input encoded data is not used, the quantization unit 1701 determines the quantization step size on its own to perform quantization.

Otherwise, the configuration and the operation are the same as in the above mentioned Exemplary Embodiments 1 to 9, and hence the corresponding explanation is dispensed with. In the present Exemplary Embodiment, the image size of the input encoded data may be converted speedily. Moreover, in the present Exemplary Embodiment, the image quality may be adjusted to be better than in the Exemplary Embodiment 8 or 9. In the present Exemplary Embodiment, the functions of various components of the moving image transcoder 1600 may naturally be implemented on a program which is run on a computer of the moving image transcoder 1600.

### Exemplary Embodiment 11

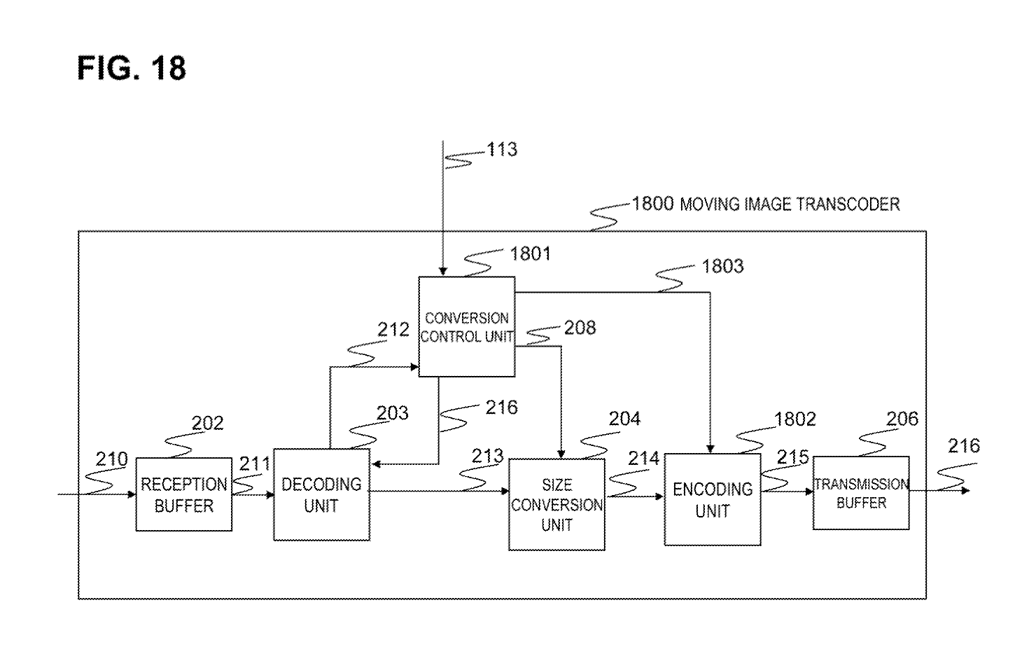

The following describes Exemplary Embodiment 11 of the present invention in detail with reference to FIGS. 1, 18 and 19. FIG. 18 shows a configuration of a moving image transcoder 1800 of Exemplary Embodiment 11 of the present invention. In FIG. 18, the elements which are the same as or equivalent to those of FIG. 2 are depicted by the same reference numerals. The moving image transcoder 1800 is arranged at a position of the moving image transcoder 109 of FIGS. 1, 4 and 5.

Referring to FIG. 18, a conversion control unit 1801 sends a size conversion request 208 to a size conversion unit 204, while transmitting conversion information 1803 to an encoding unit 1802, based upon a conversion request 113 from a capability information exchange unit 108 (403, 503) (see FIGS. 1, 4 and 5) and an encoding parameter set 212 from a decoding unit 203.

The conversion control unit 1801 sends, as the conversion information 1803,

image data size;

frame type;

prediction mode and direction;

motion vector;

reference frame information;

block size;

block type;

bit rate;

frame rate; and

filtering processing information

to the encoding unit 1802.

The filtering processing information may, for example, include

information on whether or not to execute filtering processing on image data before encoding or on image data being encoded; or

information on intensity of filtering and on area where filtering is to be executed in case the filtering processing is executed.

It is decided whether or not to execute the filtering processing, base on the following information, for example,

output bit rate for image size after size conversion;

whether image size is to be converted in enlarging direction or in contracting direction; and

whether bit rate of input encoded data is high or low.

For example, the information in the input encoded data indicating whether or not to execute the filtering processing may be used. A decision for doing the filtering processing may be given in case the output bit rate is low or in case the bit rate of the input encoded data is low in comparison with the image size following the size conversion. A decision for not doing the filtering processing may be given in case the output bit rate is high in comparison with the image size following the size conversion, or in case the bit rate of the input encoded data is high and the image size is to be reduced.

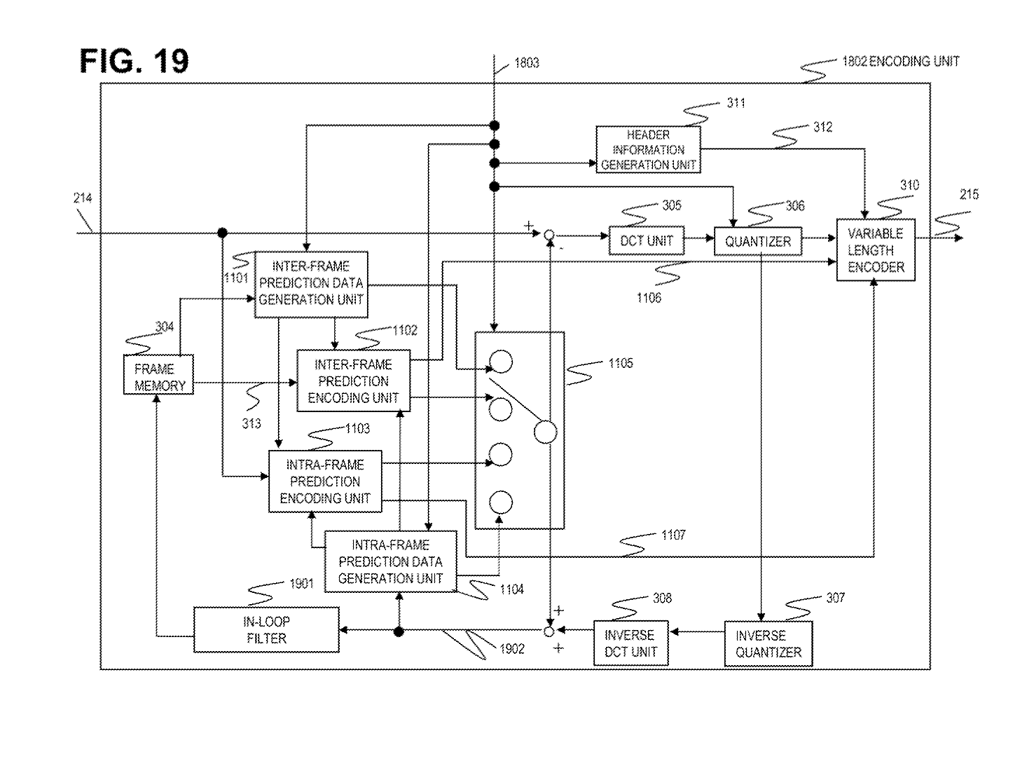

FIG. 19 shows a configuration of the encoding unit 1802 in Exemplary Embodiment 11 of the present invention. In FIG. 19, the parts which are the same as or equivalent to those of FIG. 11 are depicted by the same reference numerals. The encoding unit 1802 will now be described in detail with reference to FIG. 19.

An in-loop filter 1901 performs filtering processing, based upon the conversion information 1803 received from the conversion control unit 1801.

When filtering processing is commanded in the conversion information 1803, filtering processing to image data 1902 is executed.

If, in the conversion information 1803, there is included the information on intensity of filtering or on area in which filtering is to be executed, filtering is executed in accordance with the conversion information 1803.

If it is commanded in the conversion information 1803 not to execute filtering, the image data 1902 is sent to the frame memory 304 as it is.

In the present Exemplary Embodiment, explanation has been made for a case in which a decision is given on whether or not filtering is to be carried out on image data being encoded. However, this is merely by way of illustration and not for limiting the present invention. As will be apparent from the principle of the moving image conversion system, it may be determined whether or not filtering is to be carried out on pre-encoding image data.

Otherwise, the configuration and the operation are the same as those of Exemplary Embodiments 1 and 10, and hence are not explained. With the present Exemplary Embodiment, in converting image size of input encoded data, conversion may be made speedily to an image quality higher than in Exemplary Embodiments 1 to 10. It is observed that, with the present Exemplary Embodiment, the functions of various components of the moving image transcoder 1800 may be implemented on a program which is run on a computer of the moving image transcoder 1800.

### Exemplary Embodiment 12

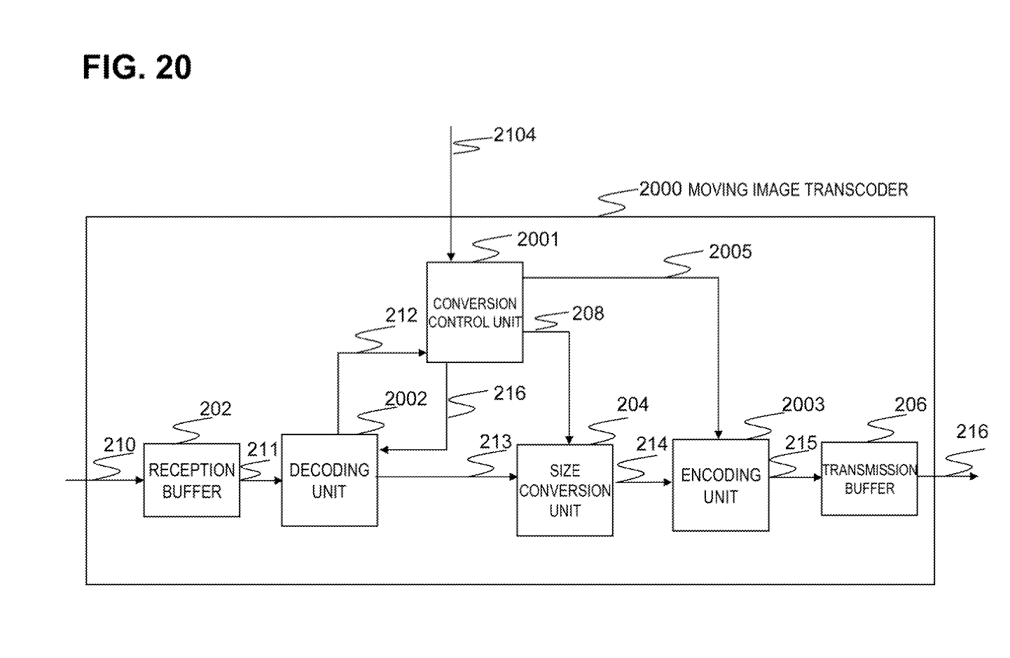

The following describes Exemplary Embodiment 12 of the present invention in detail with reference to FIGS. 1 and 20. FIG. 20 shows a configuration of a moving image transcoder 2000 of Exemplary Embodiment 12 of the present invention. In FIG. 20, the elements which are the same as or equivalent to those of FIG. 2 are depicted by the same reference numerals. The moving image transcoder 2000 is arranged at a position of the moving image transcoder 109 of FIGS. 1, 4 and 5.

Referring to FIG. 20, a conversion control unit 2001 sends a size conversion request 208 to a size conversion unit 204, while transmitting conversion information 2005 to an encoding unit 2002, based upon a conversion request 2004 from a capability information exchange unit 108 (403, 503) (see FIGS. 1, 4 and 5) and an encoding parameter set 212 from a decoding unit 203.

The conversion request 2004 may include, for example,

size conversion information;

encoding scheme for input encoded data; and

encoding scheme for output encoded data.

On receipt of the encoding parameter set 212 from the decoding unit 2002, the conversion control unit 2001 sends, based on the conversion request 2004,

image data size;

frame type;

prediction mode and direction;

motion vector;

reference frame information;

block size;

block type;

frame rate;

bit rate;

quantization information; and

filtering processing information

as the conversion information 2005, to the encoding unit 2002.

If, in the conversion request 2004, the input encoding scheme is the same as the output encoding scheme, the conversion control unit 2001 converts the encoding parameter set 212 by the same method as explained in Exemplary Embodiments 1 to 11, and sends the so converted set to the encoding unit 2002.

If, in the conversion request 2004, the input encoding scheme differs from the output encoding scheme, the conversion control unit 2001 converts

prediction mode and direction;

motion vector;

reference frame information;

block size;

block type;

picture type;

quantization information;

frame rate; and

filtering processing information

in the input encoded data to be matched to that in the output encoding scheme.

In case of the prediction mode, if the prediction mode of the input encoding data is not matched in the output encoding scheme, approximation is made to the nearest prediction mode and direction.

In case of the motion vector, an upper or lower limit value, or a measure, for example, is matched in the output encoding scheme.

In case of the reference frame information, if the reference frame information in the input encoding scheme is not matched in the output encoding scheme, the frame number is expanded or reduced to a maximum or minimum value in the output encoding scheme. On the other hand, the reference frame information irrelevant to the output encoding scheme is made not to be transmitted to the encoding scheme 2002. Or, the information of the input encoded data is not used for the relevant portion, and re-encoding is made for it.

In case of the block size, there may be a case where a single prediction mode/prediction direction as well as a single motion vector may be specified for each of 4×4 blocks in the input encoding scheme but just a single prediction mode/prediction direction or just a single motion vector may be specified for an 8×8 block or for a 16×16 block in the output encoding scheme. In such case, the prediction mode/prediction direction or the motion vector is formed by a synthesizing method shown in the Exemplary Embodiment 4.

In case of the picture type, if a certain picture type is present in the input encoding scheme but is not present in the output encoding scheme, the frame in question is re-encoded. Or, if the picture type difference is merely the addition of the information irrelevant to the output encoding scheme, the information is not transmitted but the picture type is approximated and transmitted to the encoding unit 1802. In case of the quantization step, it is converted as the upper/lower limit values or the meaning of the measure, for example, whether the scale is a log scale or whether the number is a multiple number, is taken into account.

In case of the filtering processing information, no filtering operation is carried out if the information is present in the input encoding scheme and is not present in the output encoding scheme. Or, if simply the information irrelevant to the output encoding scheme is added, such information is not transmitted and the filtering processing information is generated.

Otherwise, the configuration and the operation are the same as those of the above Exemplary Embodiments 1 to 11, and hence the explanation is dispensed with. In the present Exemplary Embodiment, it is possible to speedily change the image size of the input encoded data in case the input encoding scheme differs from the output encoding scheme. In the present Exemplary Embodiment, the functions of the moving image transcoder 2000 may naturally be implemented by a program which is run on a computer of the moving image transcoder 2000.

### Exemplary Embodiment 13

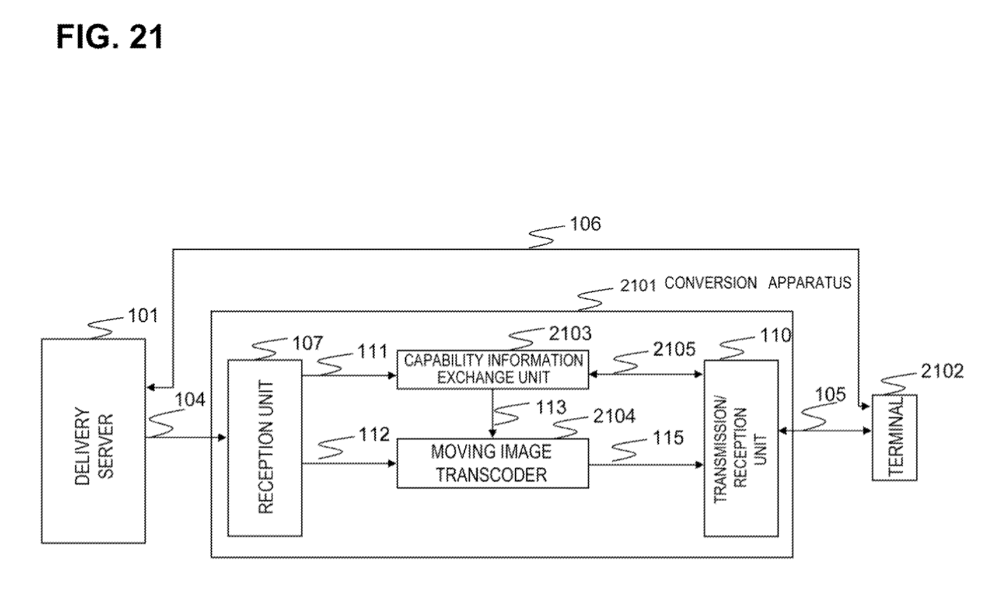

The following describes Exemplary Embodiment 13 of the present invention in detail with reference to Referring to FIGS. 21 to 23. FIG. 21 shows a configuration of a moving image delivery system of Exemplary Embodiment 13 of the present invention. In FIG. 21, the elements which are the same as or equivalent to those of FIG. 1 are depicted by the same reference numerals.

Referring to FIG. 21, the moving image delivery system of the present Exemplary Embodiment includes a delivery server 101, a conversion apparatus 2101, a terminal 2102 and transmission links 104 to 106. The conversion apparatus 2101 includes a reception unit 107, a capability information exchange unit 2103, a moving image transcoder 2104 and a transmission/reception unit 110.

The capability information exchange unit 2103 exchanges the capability information and the function information with the terminal 2102. In FIG. 21, the capability information and the function information are depicted by a reference numeral 2105. The capability information exchange unit 2103 requests the moving image transcoder 2104 to convert the input encoded data, based upon the function information, so that the input encoded data converted will be compatible with the capability information.

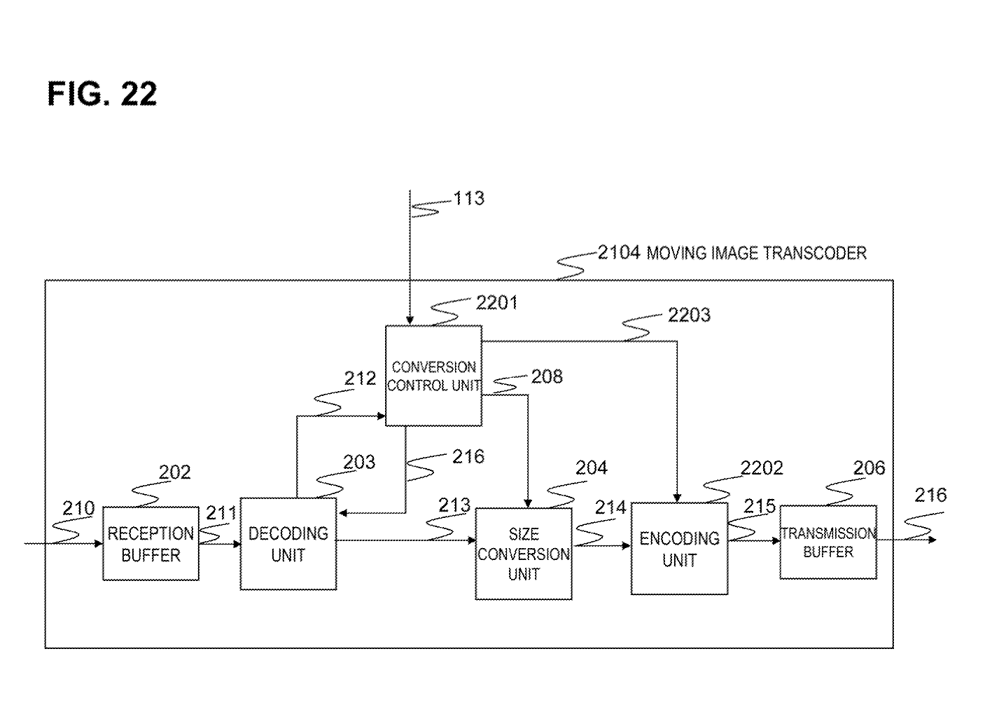

FIG. 22 shows the configuration of the moving image transcoder 2104 of FIG. 21. In FIG. 22, the elements which are the same as or equivalent to those shown in FIG. 2 are depicted by the same reference numerals. A conversion control unit 2201 sends conversion information 2203 to an encoding unit 2202, based upon the encoding information, image size information and the information on the bit rate as well as the frame rate as received from the capability information exchange unit 2103.

The conversion information 2203 may include

encoding information of output encoded data; and

command on whether or not to execute encoding.

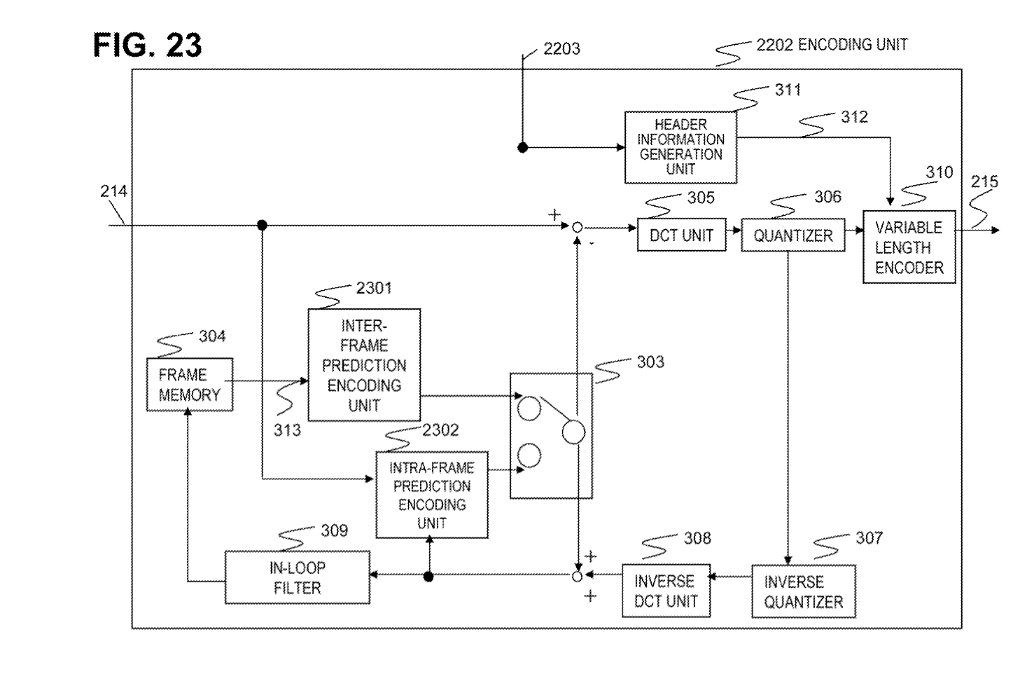

FIG. 23 shows the configuration of the encoding unit 2202 of FIG. 22. In FIG. 23, the elements which are the same or equivalent to those shown in FIG. 3 are depicted by the same reference numerals. In FIG. 23, an inter-frame prediction encoding unit 2301 and an intra-frame prediction encoding unit 2302 are the same in configuration and operation to a routine encoding unit and hence the corresponding description is dispensed with.

Otherwise, the configuration and the operation are the same as those of Exemplary Embodiments 1 and 2, and hence are not explained. In the present Exemplary Embodiment, in distributing encoded data to a terminal, the encoded data of a delivery server may be converted, by using the function information, for matching to the terminal's capability information, as deterioration of the image quality is suppressed. Moreover, since a routine encoder, such as one available on the marketplace, may be used as the encoding unit, the present Exemplary Embodiment may be used more readily than the Exemplary Embodiments 1 to 12. In the present Exemplary Embodiment, the functions of various components of the conversion apparatus 2101 and the moving image transcoder 2104 may naturally be implemented by a program which is run on a computer of the conversion apparatus 2101 and the moving image transcoder 2104.

### Exemplary Embodiment 14

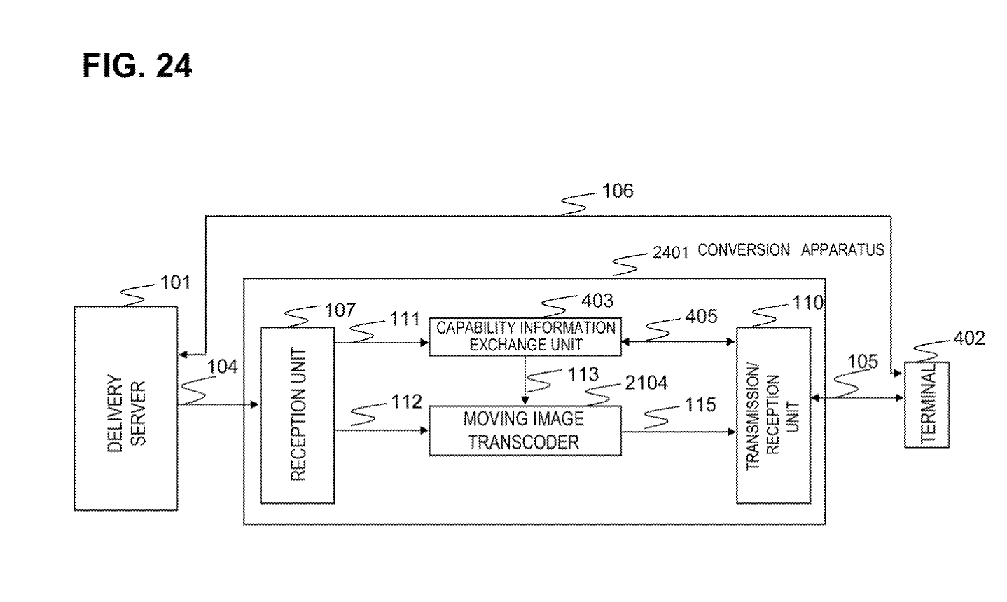

The following describes Exemplary Embodiment 14 of the present invention in detail with reference to FIGS. 22 to 24. FIG. 24 shows a configuration of a moving image delivery system. In FIG. 24, the elements which are the same as or equivalent to those of FIG. 1 are depicted by the same reference numerals. In the present Exemplary Embodiment, a moving image transcoder and an encoding unit are of the configuration of FIGS. 22 and 23.

Referring to FIG. 24, a moving image delivery system of the present Exemplary Embodiment includes a delivery server 101, a conversion apparatus 2401, a terminal 402 and transmission links 104 to 106.

The conversion apparatus 2401 includes a reception unit 107, a capability information exchange unit 403, a moving image transcoder 2104 and a transmission/reception unit 110.

The capability information exchange unit 403 exchanges capability information and function information with the terminal 402. Also, the capability information exchange unit 403 has network status information informed from the terminal 402.

Otherwise, the configuration and the operation are the same as those in the Exemplary Embodiments 1, 2 and 13, and hence the corresponding description is dispensed with. In the present Exemplary Embodiment, in distributing encoded data to the terminal, the encoded data of the delivery server may be converted, by using the function information, for matching to the terminal's capability information and to the network status, such as to suppress deterioration of image quality. Moreover, the routine type encoding unit may be used, and hence the present Exemplary Embodiment may be used more readily than the Exemplary Embodiments 1 to 12. In the present Exemplary Embodiment, the functions of various components of the conversion apparatus 2401 may naturally be implemented by a program which is run on a computer of the moving image transcoder 2401.

### Exemplary Embodiment 15

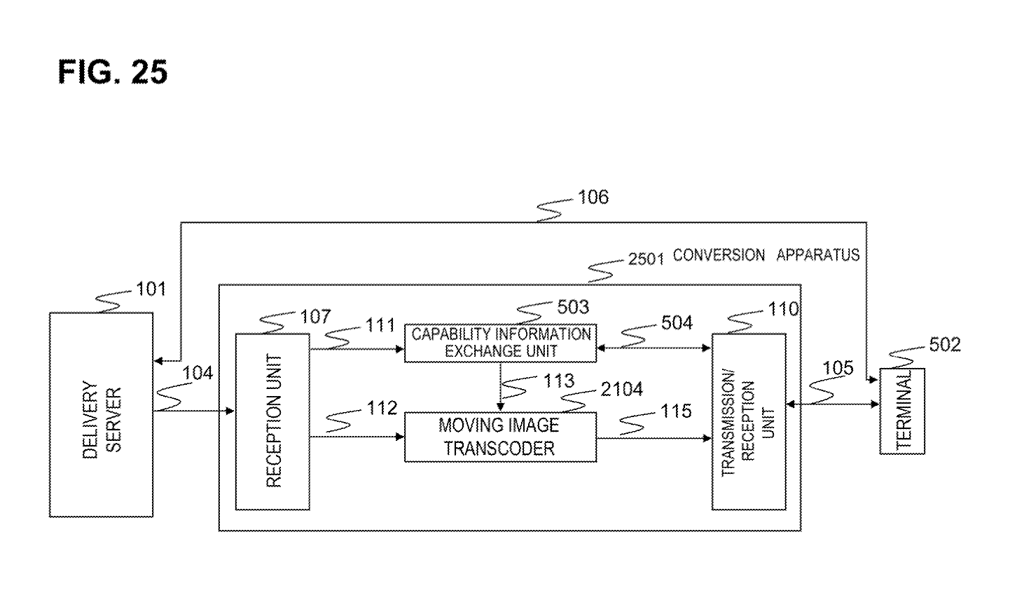

The following describes Exemplary Embodiment 15 of the present invention in detail with reference to FIGS. 22, 23 and 25. FIG. 25 shows a configuration of a moving image delivery system. In FIG. 24, the elements which are the same as or equivalent to those of FIG. 1 are depicted by the same reference numerals. In the present Exemplary Embodiment, the moving image transcoder and the encoding unit are of the configuration of FIGS. 22 and 23.

Referring to FIG. 25, a moving image delivery system of the present Exemplary Embodiment includes a delivery server 101, a conversion apparatus 2501, a terminal 502 and transmission links 104 to 106.

The conversion apparatus 2501 includes a reception unit 107, a capability information exchange unit 503, a moving image transcoder 2104 and a transmission/reception unit 110.

The capability information exchange unit 503 exchanges capability information, function information and subscriber information with the terminal 402. Also, the capability information exchange unit 503 has network status information informed from the terminal 402.

Otherwise, the configuration and the operation are the same as those in the Exemplary Embodiments 1 to 3, 13 and 14, and hence are not explained. In the present Exemplary Embodiment, in distributing encoded data to the terminal, the encoded data of the delivery server may be converted, by using the function information, for matching to the terminal's capability information or to the network status, as deterioration of the image quality is suppressed. Moreover, since the routine type encoding unit may be used, the present Exemplary Embodiment may be used more readily than the Exemplary Embodiments 1 to 12. In addition, as compared to the Exemplary Embodiments 13 and 14, it becomes possible to control the band allocation to the subscribers. In the present Exemplary Embodiment, the functions of various components of the conversion apparatus 2501 may naturally be implemented by a program which is run on a computer of the conversion apparatus 2501.

In the following, the operation and the meritorious effect of the present Exemplary Embodiment are summarized.

If, in distributing a stream to terminals having various capabilities, it is necessary to convert the stream, such stream conversion may be executed speedily.

If, in distributing a stream to terminals having various capabilities, it is necessary to convert the stream, the information of the stream received may be used to execute the conversion such as to suppress deterioration of image quality.

If, in an environment where a network status changes, it becomes necessary in stream delivery to execute stream conversion, the stream conversion may be executed speedily.

If, in an environment where a network status changes, it becomes necessary in stream delivery to execute stream conversion, the stream conversion may be executed with the use of the received stream information such as to suppress deterioration of image quality.

If, in an environment where a network status changes, it becomes necessary in stream delivery to execute stream conversion, the stream conversion may be executed by conversion to a stream at the upper limit of the terminal's decoding capability as the load on the network is suppressed.

If in an environment where a network status changes, it becomes necessary in stream delivery to execute stream conversion, and the network bandwidth should fall into shortage, the information from the terminal may be used to execute the stream conversion such as to suppress deterioration of image quality.

The whole or part of the Exemplary Embodiments disclosed above can be described as, but not limited, the following Supplementary notes.

### (Supplementary Note 1)

A delivery system that distributes at least one stream to a terminal over a network; the delivery system including

a conversion apparatus that, in distributing encoded data of a moving image specified by a terminal, re-uses information of the encoded data to convert the encoded data so that the encoded data converted fits in with at least one of the capability information and the status of the network notified from the terminal; the conversion apparatus transmitting the encoded data converted to the conversion apparatus.

### (Supplementary Note 2)

A delivery system that distributes at least one stream to a terminal over a network; the delivery system including

a conversion apparatus that, in distributing encoded data of a moving image specified by a terminal, determines whether or not to convert the encoded data, based upon the function information of the terminal from the terminal, and sends the stream to the terminal.

### (Supplementary Note 3)

The delivery system according to Supplementary note 2, wherein the conversion apparatus suppresses the bit stream of the stream distributed based upon the function information notified from the terminal.

### (Supplementary Note 4)

The delivery system according to Supplementary note 2 or 3, wherein the conversion apparatus performs operation of a function not covered by function information notified from the terminal.

### (Supplementary Note 5)

The delivery system according to any one of Supplementary note 1 to 4, wherein the delivery system further includes

a delivery server that transmits encoded data of a moving image specified by the terminal;

the conversion apparatus decoding the encoded data received from the delivery server into image data; wherein,

in converting the decoded image data so that the image data converted fits in with at least one of the capability information and the network status notified from the terminal, and wherein,

in encoding the image data converted, the conversion apparatus re-encodes the encoded data received as the conversion apparatus re-uses the information of the encoded data received; the conversion apparatus transmitting the re-encoded data to the terminal over the network.

### (Supplementary Note 6)

The delivery system according to Supplementary note 5, wherein the conversion apparatus includes

a reception unit that receives the encoded data from the delivery server;

an information exchange unit that exchanges the capability information or the function information with the terminal;

a transcoder that re-encodes the encoded data, received from the delivery server, so that the resulting re-encoded data fits in with at least one of the capability information and the status of the network notified from the terminal, as the transcoder re-uses the information of the encoded data received from the delivery server; and

a transmission unit that sends the resulting re-encoded data from the transcoder to the terminal.

### (Supplementary Note 7)

The delivery system according to Supplementary note 6, wherein the transcoder includes

a decoding unit that decodes the encoded data received;

a size conversion unit that converts the size of image data decoded by the decoding unit so that the size converted fits in with at least one of the capability information and the network status notified from the terminal; and

an encoding unit that, in encoding the image data converted by the size conversion unit, re-encodes the image data so that the re-encoded image data fits in with at least one of the capability information and/or the network status notified from the terminal, as the encoding unit re-uses the information of the encoded data received.

### (Supplementary Note 8)

The delivery system according to any one of Supplementary note 1 to 7, wherein the conversion apparatus includes means that converts at least one of image size, bit rate and frame rate in the encoded data depending upon the network status notified from the terminal and/or upon the capability information notified from the terminal.

### (Supplementary Note 9)

The delivery system according to any one of Supplementary note 1 to 8, wherein the conversion apparatus includes means that converts at least one of image size, bit rate and frame rate in the encoded data using the function information notified from the terminal.

### (Supplementary Note 10)

The delivery system according to any one of Supplementary note 1 to 9, wherein the conversion apparatus includes means that re-uses at least one of image size, bit rate and frame rate as the information of the encoded data received.

### (Supplementary Note 11)

The delivery system according to Supplementary note 10, wherein the conversion apparatus, in encoding image data after conversion, re-uses the reference frame information of the encoded data received.

### (Supplementary Note 12)

The delivery system according to any one of Supplementary note 1 to 11, wherein the conversion apparatus includes means that expands or contracts, in encoding the image data following image size conversion, at least one of motion vector and block size of the received encoded data, for matching to size ratio of the image size before conversion and image size after conversion.

### (Supplementary Note 13)

The delivery system according to any one of Supplementary note 1 to 12, wherein the conversion apparatus includes means that approximates prediction mode for the encoded data received, in case the prediction mode received is not directly usable following the size conversion.

### (Supplementary Note 14)

The delivery system according to any one of Supplementary note 1 to 13, wherein the conversion apparatus includes means that splits or synthesizes at least one of prediction mode and motion vector of encoded data received for re-use, for matching to the size ratio of a pre-conversion image size and a post-conversion image size.

### (Supplementary Note 15)

The delivery system according to any one of Supplementary note 1 to 14, wherein the conversion apparatus includes means that executes re-prediction with at least one of re-used prediction mode and re-used motion vector as start point.

### (Supplementary Note 16)

The delivery system according to Supplementary note 15, wherein the conversion apparatus includes means that uses direction of motion vector in doing re-prediction with the re-used motion vector as start point.

### (Supplementary Note 17)

The delivery system according to any one of Supplementary note 1 to 16, wherein the conversion apparatus includes means that executes re-prediction in case the prediction error is not less than a preset threshold value.

### (Supplementary Note 18)

The delivery system according to any one of Supplementary note 1 to 17, wherein the conversion apparatus includes means that re-uses quantization step size of the received encoded data in encoding the image data following the size conversion.

### (Supplementary Note 19)

The delivery system according to any one of Supplementary note 1 to 18, wherein the conversion apparatus includes means that re-uses code amount delivery of the received encoded data in encoding the image data after the size conversion.

### (Supplementary Note 20)

The delivery system according to Supplementary note 18 or 19, wherein the conversion apparatus includes means that determines whether or not to re-use at least one of quantization step size and code amount delivery of the input encoded data.

### (Supplementary Note 21)

The delivery system according to any one of Supplementary note 1 to 20, wherein the conversion apparatus includes means that re-uses picture type and block type of the received encoded data in encoding the image data after the size conversion.

### (Supplementary Note 22)

The delivery system according to any one of Supplementary note 1 to 21, wherein the conversion apparatus includes means that determines whether, in encoding image data after the size conversion, to apply filtering to the image data after the size conversion or to the image data being encoded.

### (Supplementary Note 23)

The delivery system according to any one of Supplementary note 1 to 22, wherein in the conversion apparatus, a decoding scheme and an encoding scheme differ from each other.

### (Supplementary Note 24)

A method for distributing at least one stream to a terminal over a network; the method comprising

a conversion apparatus re-using, in distributing encoded data of a moving image specified by the terminal, information of the encoded data to convert the encoded data so that the encoded data converted fits in with at least one of capability information and a status of the network, notified from the terminal; and

the conversion apparatus transmitting the encoded data converted to the terminal.

### (Supplementary Note 25)

A method for distributing at least one stream to a terminal over a network; the method comprising

a conversion apparatus determining, in distributing encoded data of a moving image specified by a terminal, whether or not to convert the encoded data, based upon function information of the terminal from the terminal;

the conversion apparatus transmitting the stream to the terminal.

### (Supplementary Note 26)

The delivery method according to Supplementary note 24, wherein the conversion apparatus converts at least one of image size, bit rate and frame rate in the encoded data, based upon at least the network status and the capability information notified from the terminal.

### (Supplementary Note 27)

The delivery method according to Supplementary note 25, wherein the conversion apparatus converts at least one of image size, bit rate and frame rate in the encoded data using the function information notified from the terminal.

### (Supplementary Note 28)

The delivery method according to Supplementary note 25 or 27, wherein the conversion apparatus performs operation of a function not covered by the function information notified from the terminal.

### (Supplementary Note 29)

The delivery method according to any one of Supplementary note 24 to 28, wherein

the conversion apparatus re-uses at least one of the prediction mode, motion vector and the block size as the information of the encoded data received.

### (Supplementary Note 30)

A program causing a computer composing a conversion apparatus to execute the processing comprising:

in distributing encoded data of a moving image specified by a terminal over a network, converting the encoded data, by re-using information of the encoded data so that encoded data converted fits in with at least one of network status and capability information notified from the terminal; and

transmitting the encoded data converted to the terminal.

### (Supplementary Note 31)

A program causing a computer composing a conversion apparatus to execute the processing comprising:

in distributing encoded data of a moving image specified by a terminal over a network, determining whether or not the encoded data is to be converted, based upon the function information of the terminal from the terminal; and

transmitting the stream to the terminal.

### (Supplementary Note 32)

A conversion apparatus comprising:

a reception unit that receives, from a delivery server, encoded data specified by a terminal, the delivery server transmitting the encoded data to the conversion apparatus;

an information exchange unit that receives capability information and/or function information of the terminal from the terminal;

a transcoder that encodes the encoded data received from the delivery server, based upon capability information and/or status of the network notified from the terminal, or using function information notified by the terminal, by re-using information on the encoded data received from the delivery server; and

a transmitting unit that transmits the encoded data from the transcoder to the terminal over a network.

### (Supplementary Note 33)

The conversion apparatus according to Supplementary note 32, wherein the transcoder includes

a decoding unit that decodes encoded data received by the reception unit into image data;

a conversion control unit that receives a conversion request from the information exchange unit or both the conversion request and encoding parameters from the decoding unit to control conversion in a size conversion unit or in an encoding unit;

the size conversion unit converting the size of image data supplied from the decoding unit, based upon a conversion command from the conversion control unit; and

the encoding unit encoding the image data output from the size conversion unit in accordance with the conversion command from the conversion control unit;

the encoding unit in encoding the image data after the size conversion in the size conversion unit, re-using at least one of prediction mode, motion vector and block size of the encoded data received.

### (Supplementary Note 34)

The conversion apparatus according to Supplementary note 33, wherein the conversion control unit supplies a size conversion request to the size conversion unit and supplies conversion information to the encoding unit, based upon the conversion request from the information exchange unit and encoding parameters from the decoding unit,

the size conversion unit exploits a multiplication factor or an input/output image size in size conversion request information from the conversion control unit to convert image size of image data received from the decoding unit to supply the image data converted to the encoding unit, and

the encoding unit includes:

an inter-frame prediction data generation unit that exploits conversion information received from the conversion control unit and image data from the frame memory to perform inter-frame prediction to generate prediction data for supply to the switch;

an intra-frame prediction data generation unit that exploits conversion information received from the conversion control unit and image data received from the size conversion unit to execute intra-frame prediction to generate prediction data for supply to the switch,

the switch changing over between the prediction data generated by the inter-frame prediction data generation unit and the prediction data generated by the intra-frame prediction data generation unit, in accordance with a command from the conversion control unit, so that the prediction data changed over is supplied to a discrete cosine transform unit, an in-loop filter and the intra-frame prediction data generation unit,

a quantization unit that determines the quantization step with bit rate commanded by the conversion control unit as a target,

a header information generation unit that generates header information based upon conversion information received from the conversion control unit; and

a variable length encoder that performs variable length encoding of an output from the quantization unit based upon header information from the header information generation unit.

The disclosures of the above mentioned Patent Documents are to be incorporated herein by reference. The particular exemplary embodiments or examples may be modified or adjusted within the gamut of the entire disclosure of the present invention, inclusive of claims, based on the fundamental technical concept of the invention. Further, a wide variety of combinations or selection of elements disclosed herein may be made within the scope of coverage by the claims. The present invention may encompass various modifications or corrections that may occur to those skilled in the art in accordance with and within the range of the entire disclosure of the present invention, inclusive of claims, and the technical concept of the present invention.

What is claimed is:

1. A delivery system that distributes at least one stream from a delivery server to a terminal over a network, said system comprising
a conversion apparatus that receives encoded data of moving image which is an object for delivery specified by said terminal, from said delivery server, converts said encoded data based upon at least one of capability information of said terminal, function information of said terminal and a status of said network, notified from said terminal, and transmits said converted encoded data to said terminal.

2. The delivery system according to claim 1, wherein said conversion apparatus re-uses information of said encoded data to convert said encoded data so that said encoded data converted fits in with at least one of capability information of said terminal and a status of said network, notified from said terminal, and transmits said converted encoded data to said terminal.

3. The delivery system according to claim 1, wherein said conversion apparatus, in distributing said encoded data of said moving image specified by said terminal, determines, based upon said capability information and said function information of said terminal, notified from said terminal, whether or not to convert said encoded data,
converts said encoded data which is determined to be converted, and
transmits said converted encoded data to said terminal.

4. The delivery system according to claim 1, wherein said function information notified by said terminal includes at least one of
image size change function,
frame interpolation function, and
stream bandwidth expansion function, and wherein
said conversion apparatus performs, based upon said function information, at least one of
changing of image size,
decimating said encoded data on a per frame basis, and
suppressing bit rate of said encoded data.

5. The delivery system according to claim 1, wherein said conversion apparatus includes:
a reception unit that receives said encoded data from said delivery server;
an information exchange unit that exchanges, with said terminal, said capability information and/or said function information of said terminal, and information on said status of said network;
a transcoder that decodes encoded data received from said delivery server into image data, said transcoder converting decoded image data so that said decoded image data converted fits in with at least one of said capability information and said status of said network, notified by said terminal, said transcoder encoding said decoded image data converted, said transcoder exploiting encoding information of said encoded data received to encode said decoded image data; and
a transmission unit that transmits said encoded data output from said transcoder over said network to said terminal.

6. The delivery system according to claim 5, wherein said information exchange unit receives, as said capability information of said terminal, at least one of
encoding information,
image size information,
bit rate, and
frame rate, wherein
said information exchange unit compares encoding information of said encoded data from said reception unit and said encoding information notified from said terminal to decide whether or not to convert said encoded data received from said delivery server, and
said information exchange unit, in case of decision being made to convert said encoded data received, notifies a conversion request to said transcoder, said conversion request including at least one of
image size after conversion,
bit rate, frame rate, and
encoding information, and wherein,
said information exchange unit, when notified from said terminal of said status of said network, notifies a conversion request to said transcoder, said conversion request including at least one of image size after conversion,
bit rate,
frame rate, and
encoding information, associated with said network status.

7. The delivery system according to claim 6, wherein said transcoder includes:
a decoding unit that decodes said encoded data received;
a conversion control unit that generates conversion information for converting at least one of image size, bit rate, and frame rate in said encoded data, based upon said conversion request from said information exchange unit and encoding information from said decoding unit;
a size conversion unit that converts size of image data decoded by said decoding unit in accordance with said conversion information of image size from said conversion control unit; and
an encoding unit that receives image data output from said size conversion unit and that encodes said image data based upon said conversion information from said conversion control unit.

8. The delivery system according to claim 7, wherein said conversion information notified from said conversion control unit of said transcoder to said encoding unit includes at least one of
image data size,
frame type,
prediction mode and direction,
motion vector,
reference frame information,
block size,
block type,
frame rate,
bit rate,
quantization information, and
filtering processing information.

9. The delivery system according to claim 7, wherein said encoding unit of said transcoder, in encoding image data output from said size conversion unit, executes at least one of
re-using reference frame information of said encoded data received, and
expanding or contracting at least one of motion vector and block size of said encoded data received in accordance with a ratio between image size before conversion and that after conversion.

10. The delivery system according to claim 1, wherein said conversion control unit of said transcoder converts, in case an input encoding scheme differs from an output encoding scheme in a conversion request from said information exchange unit, at least one of
prediction mode and direction,
motion vector,
reference frame information,
block size,
block type,
picture type,
quantization information:
frame rate, and
filtering processing information,
in encoded data received so as to match to that of said output encoding scheme.

11. The delivery system according to claim 7, wherein said conversion control unit of said transcoder splits or composes at least one of prediction mode and motion vector of said encoded data received, for re-use, in accordance with a ratio between image size before conversion and that after conversion.

12. The delivery system according to claim 10, wherein said conversion control unit of said transcoder executes, in connection with an input encoding scheme and an output encoding scheme, at least one of
approximating prediction mode and direction;
making motion vector match to that of an output encoding scheme;
enlarging or contracting reference frame information to a maximum or minimum value of an output encoding scheme, not transmitting reference frame information irrelevant to an output encoding scheme to said encoding unit or executing re-encoding without using information of input encoded data for a portion in question;
combining said prediction mode and direction and said motion vector, in case said block size is different;
re-encoding a frame in question or approximating an picture type to send a picture type approximated frame to said encoding unit, in case a picture type is present in said input encoding scheme and not present in said output encoding scheme;
making said quantization step match to that in said output encoding scheme; and
not performing filtering processing, or in case just said information irrelevant to said output encoding scheme is added, generating said filtering processing information, in case said filtering processing is present in said input encoding scheme and is not present in said output encoding scheme.

13. The delivery system according to claim 10, wherein said encoding unit of said transcoder performs at least one of
executing re-prediction using at least one of prediction mode and motion vector re-used as start point;
in case of executing re-prediction with re-used motion vector as start point, using direction of motion vector; and
executing prediction anew in case of a prediction error being greater than a predetermined threshold.

14. The delivery system according to claim 1, wherein, in encoding image data whose size is changed by said size conversion unit, said encoding unit of said transcoder performs at least one of
re-using quantization step size of said encoded data received;
re-using code amount delivery of said encoded data received;
re-using picture type or block type of said encoded data received; and
determining whether or not to apply filtering to image data after size conversion or image data being encoded.

15. A method for distributing at least one stream from a delivery server to a terminal over a network, said method comprising:
a conversion apparatus receiving encoded data of a moving image specified by said terminal from said delivery server;
said conversion apparatus converting said encoded data based upon capability information of said terminal, function information of said terminal, or a status of said network, notified from said terminal; and
said conversion apparatus transmitting said encoded data converted to said terminal.

16. The method for delivery according to claim 15, comprising
said conversion apparatus re-using information of said encoded data to convert said encoded data so that said encoded data converted fits in with at least one of said capability information of said terminal and said status of said network, notified from said terminal, and
said conversion apparatus transmitting said converted encoded data to said terminal.

17. The method for delivery according to claim 15, comprising
said conversion apparatus, in distributing said encoded data of said moving image specified by said terminal, determining, based upon said capability information and said function information of said terminal, notified from said terminal, whether or not to convert said encoded data;
said conversion apparatus converting said encoded data which is determined to be converted; and
said conversion apparatus transmitting said converted encoded data to said terminal.

18. A conversion apparatus comprising:
a reception unit that receives encoded data from a delivery server, said delivery server transmitting encoded data specified by a terminal to said conversion apparatus to distribute at least one stream to said terminal over a network;
an information exchange unit that receives capability information and/or function information of said terminal from said terminal;
a transcoder that encodes said encoded data, received from said delivery server, based upon said capability information and/or a status of said network notified from said terminal, or using said function information notified by said terminal, by re-using information on said encoded data received from said delivery server; and
a transmitting unit that transmits said encoded data from said transcoder to said terminal over a network.

19. The conversion apparatus according to claim 18, wherein said transcoder includes:
a decoding unit that decodes said encoded data received by said reception unit into image data;
a size conversion unit;
an encoding unit; and
a conversion control unit that receives a conversion request from said information exchange unit or both said conversion request and encoding parameters from said decoding unit to control conversion in said size conversion unit and/or in said encoding unit;
said size conversion unit converting said size of image data supplied from said decoding unit, based upon a conversion command from said conversion control unit,
said encoding unit encoding said image data output from said size conversion unit in accordance with said conversion command from said conversion control unit,
said encoding unit, in encoding said image data after said size conversion in said size conversion unit, re-using at least one of prediction mode, motion vector and block size of said encoded data received.

20. The conversion apparatus according to claim 19, wherein said conversion control unit supplies a size conversion request to said size conversion unit and supplies conversion information to said encoding unit, based upon said conversion request from said information exchange unit and encoding parameters from said decoding unit,
said size conversion unit exploits a multiplication factor or an input/output image size in size conversion request information from said conversion control unit to convert image size of image data received from said decoding unit to supply said image data having said image size converted to said encoding unit, and
said encoding unit includes:
an inter-frame prediction data generation unit that exploits conversion information received from said conversion control unit and image data from a frame memory to perform inter-frame prediction to generate prediction data for supply to a switch;
an intra-frame prediction data generation unit that exploits conversion information received from said conversion control unit and image data received from said size conversion unit to execute intra-frame prediction to generate prediction data for supply to said switch,
said switch changing over between said prediction data generated by said inter-frame prediction data generation unit and said prediction data generated by said intra-frame prediction data generation unit, in accordance with a command from said conversion control unit, so that said prediction data changed over is supplied to a discrete cosine transform unit, an in-loop filter and said intra-frame prediction data generation unit,
a quantization unit that determines said quantization step with bit rate commanded by said conversion control unit as a target,
a header information generation unit that generates header information based upon conversion information received from said conversion control unit; and
a variable length encoder that performs variable length encoding of an output from said quantization unit based upon header information from said header information generation unit.
